(19) United States
(12) Patent Application Publication
(10) Pub. No.: US 2023/0303861 A1
(43) Pub. Date: Sep. 28, 2023

(54) Slippery and Anti-Fouling Liquid-Infused Coatings Fabricated from Biodegradable and Biocompatible Components

(71) Applicant: Wisconsin Alumni Research Foundation, Madison, WI (US)

(72) Inventors: David LYNN, Middleton, WI (US); Harshit AGARWAL, Madison, WI (US)

(21) Appl. No.: 18/189,885

(22) Filed: Mar. 24, 2023

Related U.S. Application Data
(60) Provisional application No. 63/323,752, filed on Mar. 25, 2022.

(51) Int. Cl. C09D 5/16; C08G 63/78; C08G 63/08

(52) U.S. Cl. CPC C09D 5/1637; C08G 63/78; C08G 63/08

(57) ABSTRACT

The present invention provides slippery liquid-infused porous surfaces (SLIPS), slippery nanoemulsion-infused porous surfaces (SNIPS), lubricant-impregnated surfaces (LIS), and other materials fabricated using polymers, linkers, and/or liquids and emulsions that are degradable (preferably biodegradable) and biocompatible. In addition to having reduced negative environmental effects, these coatings exhibit durable and robust anti-fouling properties against a wide range of substances and organisms, and advance new approaches to the design of biodegradable and sustainable liquid-infused materials.

### CROSS-REFERENCE TO RELATED APPLICATIONS

This application claims priority from U.S. Provisional Patent Application No. 63/323,752, filed Mar. 25, 2022, which is incorporated by reference herein to the extent that there is no inconsistency with the present disclosure.

### STATEMENT REGARDING FEDERALLY SPONSORED RESEARCH OR DEVELOPMENT

This invention was made with government support under 1720415 awarded by the National Science Foundation. The government has certain rights in the invention.

### BACKGROUND OF THE INVENTION

Accumulation of unwanted material on surfaces, or surface fouling, is a widespread problem in industrial, healthcare, and consumer settings, and can lead to costly economic burdens or, in biomedical and clinical contexts, to pain, suffering, and loss of life (see Marine and Industrial Biofouling, 1 ed., Springer, 2009; and The Role of Biofilms in Device-Related Infections, Vol. 3, 1 ed., Springer, 2009). Surfaces and coatings that are resistant to fouling in aqueous, biological, and marine environments therefore have enormous practical utility. Many strategies have been used to design such materials, most of which are based on chemical functionalization, structural modification of the substrate, or some combination of both (Tuteja et al., Science 2007, 318: 1618; Banerjee et al., Adv. Mater. 2011, 23: 690-718; Yao et al., Adv. Mater. 2011, 23: 719-734; Liu et al., Annual Review of Materials Research 2012, 42: 231-263; Campoccia et al., Biomaterials 2013, 34: 8533-8554; Chu et al., Chem. Soc. Rev. 2014, 43: 2784-2798; and Zander et al., ACS Macro Lett. 2018, 7: 16-25).

However, despite decades of research and development, several important issues associated with the design, production, and application of anti-fouling materials remain unaddressed, including concerns related to functional failure in complex environments and the use of building blocks and design approaches (e.g., use of perfluorinated compounds) that pose environmental concerns. In general, the design of physically and chemically robust anti-fouling surfaces that are simple, scalable, and sustainable remains a significant challenge.

Slippery liquid-infused porous surfaces (SLIPS), slippery nanoemulsion-infused porous surfaces (SNIPS), and lubricant-impregnated surfaces (LIS) comprise a relatively new class of synthetic soft materials fabricated by the infusion of lubricating liquids into chemically compatible nanoporous, microporous, or topographically patterned surfaces (see, for example, Wong et al., Nature 2011, 477 (7365): 443-447; Manabe et al., ACS Applied Materials & Interfaces 2015, 7 (8): 4763-4771; Huang et al., ACS Macro Letters 2013, 2 (9): 826-829; Lafuma et al., EPL (Europhysics Letters) 2011, 96 (5): 56001; Manna and Lynn, Advanced Materials 2015, 27 (19): 3007-3012; Smith et al., Soft Matter 2013, 9: 1772-1780; Sotiri et al., Exp. Biol. Med. 2016, 241: 909-918; Solomon et al., Non-wettable Surfaces: Theory, Preparation and Applications, The Royal Society of Chemistry, 2017, pp. 285-318; Villegas et al., ACS Nano 2019, 13: 8517-8536; Regan et al., Curr. Opin. Colloid Interface Sci. 2019, 39: 137-147; and Agarwal et al., 2021, 28: 33652-33663).

These materials are fabricated by the infusion of a lubricating liquid, typically a hydrophobic oil, into a chemically compatible porous or textured solid matrix, yielding surfaces with smooth and mobile interfaces. Provided that the chemical properties of the lubricant and the underlying surfaces are suitably matched, these materials present a “slippery” layer of mobile fluid at the surface that can repel other immiscible fluids or substances with which they come in contact (Wong et al., Nature 2011, 477 (7365): 443-447; Preston et al., ACS Applied Materials & Interfaces 2017, 9 (48): 42383-42392; Schellenberger et al., Soft Matter 2015, 11 (38): 7617-7626; and Smith et al., Soft Matter 2013, 9 (6): 1772-1780).

For instance, SLIPS and LIS can shed droplets of aqueous solutions at very low sliding angles (e.g., angles less than 5° from horizontal), endowing these materials with robust anti-icing, anti-frosting, and anti-fouling properties (see also Stamatopoulos et al., ACS Applied Materials & Interfaces 2017, 9 (11): 10233-10242; Dou et al., ACS Applied Materials & Interfaces 2014, 6 (10): 6998-7003; Subramanyam et al., Langmuir 2013, 29 (44): 13414-13418; Kim et al., ACS Nano 2012, 6 (8): 6569-6577; Ma et al., Colloids and Surfaces A: Physicochemical and Engineering Aspects 2019, 577: 17-26; Sunny et al., Proceedings of the National Academy of Sciences 2016, 113 (42): 11676; Leslie et al., Nature Biotechnology 2014, 32 (11): 1134-1140; and Liu et al., Advanced Materials 2013, 25 (32), 4477-4481).

Depending on the nature of the infused oil, these materials can also prevent fouling by complex fluids, including commercial and industrial liquids and gels, and prevent bio-fouling by microorganisms (see also Manna et al., Adv Funct Mater 2016, 26 (21): 3599-3611; Epstein et al., Proceedings of the National Academy of Sciences 2012, 109 (33): 13182; Sotiri et al., Experimental Biology and Medicine 2016, 241 (9): 909-918; and Li et al. ACS Applied Materials & Interfaces 2013, 5 (14): 6704-6711). For example, reports demonstrate that SLIPS can be designed to resist fouling by bacteria and other marine organisms that can colonize and form biofilms on biomedical devices or commercial and industrial equipment (see Epstein et al., Proc. Natl. Acad. Sci. U.S.A. 2012, 109, 13182; Leslie et al., Nat. Biotechnol. 2014, 32, 1134; Howell et al., ACS Appl. Mater. Inter. 2014, 6, 13299; Li et al., ACS Appl. Mater. Inter. 2013, 5, 6704; and Xiao et al., ACS Appl. Mater. Inter. 2013, 5, 10074).

These studies suggest that appropriately designed liquid-infused surfaces can resist the attachment, colonization, and organization of communities of these organisms in ways that exceed those exhibited by some conventional anti-fouling surfaces (such as surfaces modified with polyethylene glycol and non-wetting superhydrophobic surfaces, etc.), even in complex media with proteins, surfactants, or at high ionic strengths typical of environmental conditions encountered in many applied and biologically relevant contexts.

Additionally, SLIPS and LIS materials can be loaded with active agents, where the active agents are able to be controllably released into surrounding environments over time, either to further enhance anti-fouling properties or to impart other useful functions (see, for example, U.S. Pat. No. 10,557,042; Manna et al., Advanced Functional Materials, 2016, 26(21):3599-3611; Kratochvil et al., ACS Infect. Dis. 2016, 2: 509-517; Goudie et al., Sci. Rep. 2017, 7: 13623; Homeyer et al., ACS Biomater. Sci. Eng. 2019, 5: 2021-2029; Agarwal et al., Chemical Communications, 2021, 57: 12691-12694; and Agarwal et al., ACS Applied Materials and Interfaces, 2021, 13: 55621-55632).

In addition to strong anti-fouling properties, these materials also offer platforms for fabricating complex and responsive interfaces by manipulating the functional properties of either the infused liquid or the underlying porous matrix (Regan et al., Curr. Opin. Colloid Interface Sci. 2019, 39: 137-147; Yao et al., Nat. Mater., 2013, 12: 529-534; and Wang et al., Nature 2018, 559: 77-82). As a result, these materials have attracted significant attention in the context of a wide range of applications, including to prevent biofouling, reduce drag, impart anti-icing properties, and manipulate the behaviors of droplets on surfaces (Epstein et al., Proc. Natl. Acad. Sci. U.S.A. 2012, 109: 13182-13187; Xiao et al., ACS Appl. Mater. Interfaces 2013, 5: 10074-10080; Leslie et al., Nat. Biotechnol. 2014, 32: 1134-1140; Manabe et al., ACS Appl. Mater. Interfaces 2015, 7: 4763-4771; Kratochvil et al., ACS Infect. Dis. 2016, 2: 509-517; Yuan et al., ACS Appl. Mater. Interfaces 2016, 8: 21214-21220; Solomon et al., Langmuir 2014, 30: 10970-10976; Rosenberg et al., Phys. Fluids 2016, 28: 015103; Kim et al., ACS Nano 2012, 6: 6569-6577; and Subramanyam et al., Langmuir 2013, 29: 13414-13418). Over the last decade, major advances have been made related to the manufacturing, versatility, and durability of SLIPS-based materials, and several leading designs have been commercialized to prevent fouling in aqueous, biological, and marine environments.

These materials are therefore of interest for a range of applications, including consumer packaging and containers, industrial and maritime coatings, medical devices, and sensors. However, the growing importance and rapid commercial adoption of these anti-fouling materials raise questions about potential environmental impacts associated with the production, utilization, and persistence of liquid-infused surfaces and, in general, the sustainable design of SLIPS and LIS remains a challenge.

Accordingly, slippery and anti-fouling materials having improved degradability and/or biocompatibility are needed.

### SUMMARY OF THE INVENTION

The present invention provides materials and methods of making biocompatible and/or degradable materials, where at least one surface of the material utilizes a lubricating liquid or emulsion. Preferably, the materials are ‘slippery’ in that liquid droplets and other compounds, such as aqueous fluids, organic compounds, and microorganisms, are able to easily slide off the surface without adhering to the surface.

One aspect of the invention provides strategies for the design of polymer-based SLIPS, SNIPS and LIS materials that are readily degradable and can be constructed entirely from common and readily available building blocks that are degradable, edible, or generally regarded to be biocompatible.

Preferably, these degradable materials resist or prevent fouling by a broad range of liquids, materials, and organisms, including common bacterial and fungal pathogens. The materials and fabrication methods described herein also provide opportunities to incorporate controlled release behaviors. For example, in an embodiment, the material contains a molecular cargo able to be released at rates that can be manipulated by the physical and chemical properties (e.g., the viscosity or chemical structure) of the infused liquid and/or by the degradation or other properties of the polymer matrix. The fabrication approaches are straightforward to implement, scalable, and can be used to generate durable coatings on objects of arbitrary shape and size.

One aspect of the invention comprises infusing lubricating liquids and emulsions, including but not limited to those comprising vegetable oils and other food oils, into nanofiber-based porous materials. Optionally, such nanofiber-based materials are matrices, including but not limited to those fabricated into meshes and mats, having porous structures and high internal surface areas able to host liquid components. Preferably, the nanofiber-based materials comprise one or more polymers. In an embodiment, the nanofiber-based materials are fabricated by electrospinning or blow spinning.

One embodiment of the present invention provides an anti-fouling degradable material, wherein the material comprises: a) a porous matrix comprising one or more degradable polymers, one or more biocompatible polymers, one or more degradable linkers, or combinations thereof; and b) a lubricating liquid or an emulsion covering a first surface of the porous matrix, wherein the lubricating liquid or emulsion at least partially fills the pores of the porous matrix. Preferably, the lubricating liquid or emulsion at least partially filling the pores of the degradable porous matrix allows other liquids and compounds to contact the degradable material without adhering to the degradable material. In an embodiment, the lubricating liquid or emulsion allows other liquids and compounds to slide off the first surface without adhering to the first surface. In an embodiment, the porous matrix is a degradable porous matrix. Optionally, the degradable porous matrix comprises one or more degradable polymers, one or more degradable linkers, or both. Preferably, the lubricating liquid or emulsion also comprises a degradable, biodegradable, and/or biocompatible material. Optionally, the porous matrix is a nanofiber mesh or a nanofiber mat, where the fibers are on the micron scale or, preferably, in the nanoscale range. The fiber mats or meshes are able to be fabricated using any method known in the art, including electrospinning, blow spinning, melt spinning, dry spinning, wet spinning and gel spinning.

In an embodiment, providing a porous matrix comprises electrospinning or blow spinning a nanofiber-based mesh or fiber mat. Electrospinning is a method for producing ultrafine fibers by charging and ejecting a polymer melt or solution through a spinneret under a high-voltage electric field, followed by solidifying or coagulating to form a filament (see, for example, Bhardwaj et al., Biotechnology Advances 2010, 28(3): 325-347; and Subbiah et al., Journal of Applied Polymer Science 2005, 96: 557-569). Blow spinning is a method for producing ultrafine fibers using an apparatus having concentric nozzles, where a polymer solution is ejected through an inner nozzle while a constant, high velocity gas flow is sustained through the outer nozzle (see, for example, Medeiros et al., Journal of Applied Polymer Science 2009, 113: 2322-2330; and Daristotle et al., ACS Appl. Mater. Interfaces 2016, 8(51): 34951-34963). This allows the solvent component to evaporate and deposit strands of the polymer. Preferably, the filaments formed by electrospinning and blow spinning are in the micron scale range, more preferably in the nanometer scale range.

As used herein, the term “degradable” refers to materials that undergo chain-cleavage reactions, or other type of chemical reactions or modifications, under specific conditions and environments. These materials include chemically degradable materials, which undergo cleavage of chemical bonds or the formation of new chemical compounds, hydrolytically degradable materials, which are able to degrade upon contact with water, and biodegradable materials, which break down when exposed to the environment and often into natural byproducts. As used herein, the term “biodegradable” refers to materials that are able to decay or be broken down by the action of living things, such as microorganisms, or by exposure to a natural environment, such as water or sunlight. In an embodiment, the biodegradable materials of the present invention are able to decay or be broken down into environmentally innocuous, non-harmful, or non-toxic products. The chemically degradable, hydrolytically degradable, and biodegradable materials used in the present invention include, but are not limited to, chemically degradable, hydrolytically degradable, and biodegradable polymers, linkers, oils, and/or emulsions.

In certain embodiments, both the polymer matrix and the oil or emulsion comprise degradable materials, including biodegradable materials. In an embodiment, the porous matrix comprises one or more degradable polymers while the oil or emulsion is not significantly degradable. In an embodiment, the porous matrix comprises degradable linkers that link the polymers to one another. The covalent bonds linking the polymers together will be cleaved as the linkers degrade. In this embodiment, the polymers may or may not also be degradable. Optionally, the degradable materials described herein only begin to significantly degrade after exposure to specified molecules or environmental conditions, including but not limited to exposure to one or more of: water, microorganisms, changes in temperature, changes in pH, aerobic environments, oxidizing/reducing agents, sunlight, ultraviolet light, and combinations thereof. In an embodiment where a degradable porous matrix is covered by the lubrication liquid or emulsion, the porous matrix begins to degrade after the loss of the lubricating liquid or emulsion.

In an embodiment, the polymers used to form the porous matrix may comprise any chemically degradable, biodegradable, and/or biocompatible polymer known in the art, including but not limited to: polylactide, polyglycolide, poly(lactic acid-co-glycolic acid), polycaprolactone, poly(sebacic acid), polystyrene, polyvinyl chloride, polyethylene terephthalate, polypropylene, polyorthoester, polyphosphoester, polyester-amide, poly (3-hydroxybutyric acid), poly(adipic acid), polyanhydride, poly(butylene succinate) polyester, combinations thereof, and copolymers thereof. Preferably, the one or more degradable polymers are selected from the group consisting of polylactide, polyglycolide, polycaprolactone, poly(sebacic acid), combinations thereof, and copolymers thereof. In an embodiment, the nanofiber-based materials are matrices comprising poly(ε-caprolactone) (PCL), a hydrophobic polyester widely used in biomedical applications.

In an embodiment, at least 50% of the polymer is able to degrade (i.e., 50% of the backbone bonds of the polymer are cleaved) within a 15 year period of time, within a 10 year period of time, within an 8 year period of time, within a 6 year period of time, within a 5 year period of time, within a 4 year period of time, within a 36 month period of time, within a 24 month period of time, within a 12 month period of time, within a 6 month period of time, within a 3 month period of time, or within a 1 month period of time. In a further embodiment, at least 50% of the polymer is able to degrade within a 20 day period of time, within a 10 day period of time, within a 7 day period of time, within a 4 day period of time, or within a 2 day period of time. In an embodiment, at least 5% of the material by weight is able to degrade within a 12 month period of time, at least 10% of the material by weight is able to degrade within a 12 month period of time, at least 20% of the material by weight is able to degrade within a 12 month period of time, at least 30% of the material by weight is able to degrade within a 12 month period of time, at least 50% of the material by weight is able to degrade within a 12 month period of time, or at least 60% of the material by weight is able to degrade within a 12 month period of time. In some aspects of the invention, it is desirable that significant degradation not occur until after a specified period of time has elapsed. In an embodiment, no more than 10% of the polymer degrades within 20 days, within 10 days, within 1 month, within 6 months, within 1 year, within 2 years, within 3 years, or within 5 years.

In an embodiment, the degradation of the material results in changes in the physical or chemical properties of the material, such as changes in the sliding time of liquid droplets and other compounds on the surface of the material, hydrophobicity or hydrophilicity of the material, chemical reactivity of the material, changes in the physical appearance of the material (e.g., color, refractive index etc.), and combinations thereof. For example, degradation of the material may result in the material becoming more hydrophobic or less hydrophobic, and can either increase or decrease the sliding time of liquid droplets and other compounds on the surface of the material. In an embodiment, degradation of the material results in the material becoming less hydrophobic.

In an embodiment, the porous matrix has nanoscale, microscale, or macroscale porosity. For example, in one embodiment the porous matrix has nanoscale or microscale porosity, while in an alternative embodiment, the porous matrix has macroscale porosity. Preferably, the porous matrix comprises a plurality of pores having a pore size from 100 nm to 50 μm, 100 nm to 5,000 nm, 100 nm to 1,000 nm, 200 nm to 1,000 nm, 200 nm to 950 nm, or 500 nm to 950 nm.

Optionally, the lubricating liquid or emulsion comprises a natural or synthetic oil selected from the group consisting of: a hydrocarbon-based oil, a silicone oil, an edible food derived oil, a biomass-derived oil, a mineral oil, a perfluorinated oil, a liquid crystalline material, and combinations thereof. In some embodiments, the lubricating liquid or emulsion is an edible, biocompatible, or biodegradable composition, including but not limited to vegetable oil or seed oil. In an embodiment, the lubricating liquid or emulsion comprises an oil selected from the group consisting of: canola oil, coconut oil, olive oil, almond oil, corn oil, rapeseed oil, soybean oil, cannabidiol (CBD) oil, and combinations thereof.

In an embodiment, the lubricating liquid or emulsion is an emulsion comprising a liquid continuous phase and a plurality of liquid droplets dispersed within the continuous phase. Optionally, the liquid continuous phase comprises a natural or synthetic oil selected from the group consisting of: a hydrocarbon-based oil, a silicone oil, a biomass-derived oil, an edible food derived oil, a mineral oil, a perfluorinated oil, a thermotropic liquid crystal, and combinations thereof, and the liquid droplets comprise water or another aqueous solution. In some embodiments, the liquid continuous phase comprises an edible or biodegradable oil as described above. The materials preferably also comprise one or more surfactants to help form or maintain the emulsion. In an embodiment, the one or more surfactants comprise sorbitan monooleate (span 80), polyoxyethylene sorbitan monooleate (polysorbate 80), or combinations thereof.

In an embodiment, the continuous phase of the emulsion is hydrophobic and the droplets of the dispersed phase comprise water or a hydrophilic liquid. For example, the emulsion may be a water-in-oil emulsion. Alternatively, the continuous phase may be hydrophilic and the dispersed droplets are hydrophobic, such as in an oil-in-water emulsion. Alternatively, the emulsion may be a complex emulsion, such as oil-in water-in-oil and water-in-oil-in-water-in-oil emulsions. In an embodiment, the plurality of liquid droplets comprise water or other aqueous solutions.

Preferably, the emulsion is a nanoemulsion or macroemulsion where the liquid droplets of the dispersed phase have an average diameter between 10 nm and 100 μm, between 50 nm and 5 μm, between 50 nm and 1 μm, between 100 nm and 900 nm, between 100 nm and 500 nm, between 100 nm and 200 nm, between 200 nm and 800 nm, or between 200 nm and 500 nm.

In an embodiment, liquids, microorganisms and/or compounds are able to slide off the surface of the anti-fouling materials of the present invention with sliding angles of 70° or less, 50° or less, 40° or less, 30° or less, 20° or less, 10° or less, preferably 5° or less, 2.5° or less, or 2° or less.

In an embodiment, the material further comprises one or more molecules dispersed within the lubricating liquid, emulsion, or degradable polymer matrix, wherein the material is able to controllably release the one or more molecules when the material is immersed into the surrounding environment. For example, the one or more molecules may be dispersed within an oil forming the lubricating liquid or emulsion, or within the liquid droplets of the emulsion. Alternatively, the molecules may be dispersed along the surface or contained within the pores of the matrix. Optionally, the material comprises an emulsion comprising: a) a liquid continuous phase comprising a hydrocarbon-based oil, b) a plurality of liquid droplets dispersed within the continuous phase, where the plurality of liquid droplets comprise water, and c) one or more molecules dispersed within the emulsion, where the one or more molecules are hydrophilic. Optionally, at least 50% of the one or more molecules dispersed or contained within the lubricating liquid, emulsion, or polymer matrix are released to the surrounding environment within 200 days, 100 days, within 50 days, within 30 days, within 20 days, within 10 days, within 48 hours, or within 24 hours.

In an embodiment, the surrounding environment is a liquid environment, such as a liquid medium. Alternatively, the surrounding environment can be a gas medium, such as air. The lubricating liquid or emulsion at least partially fills the pores of the porous matrix, and the material is able to controllably release the one or more molecules into the surrounding environment, such as when the material is immersed into a liquid medium.

In an embodiment, the surrounding medium is an aqueous medium where the surface may encounter fungi, bacteria, and/or other microorganisms. Types of surrounding media include, but are not limited to, salt water environments (such as sea water or saline solutions), fresh water environments (such as swamp water or fresh lake water), and physiological or physiologically relevant media (including but not limited to phosphate-buffered saline solutions, TRIS-buffered saline solutions, HEPES-buffered saline solutions, Ringer's solution, cell culture media as known in the art, blood or blood plasma, and other bodily fluids).

The one or more molecules dispersed within the lubricating liquid, emulsion, or polymer matrix can be any molecule having a desired function when released into the surrounding environment, and can include hydrophobic, hydrophilic and amphiphilic molecules. In an embodiment, the molecules released by the materials of the present invention comprise hydrophilic molecules. In an embodiment, the molecules to be released by the materials comprise hydrophobic molecules.

In one aspect of the invention, the materials are able to sustain the release of molecules, including hydrophobic, hydrophilic and/or amphiphilic molecules able to prevent adhesion and colonization by fungal and bacterial pathogens. These molecules may further be able to kill and/or attenuate the colonization and virulence of non-adherent pathogens in surrounding media. For example, the coating may promote the sustained release of broad-spectrum antimicrobial agents, antifungal agents, antibacterial agents, agents that modulate bacterial or fungal quorum sensing, agents that attenuate virulence, or combinations thereof.

Preferably, the one or more molecules released by the material are able to reduce, inhibit, or modulate the behaviors of non-adherent pathogens in the surrounding media. As non-limiting examples, the molecules to be released kill or otherwise reduce at least a portion of the pathogens, slow reproduction or growth of least a portion of pathogens, or modulate behavior such as preventing or reducing the ability of pathogens to communicate with each other. In an embodiment, the molecules to be released comprise natural or synthetic antibiotic agents, natural or synthetic antifungal agents, quorum sensing modulators, or combinations thereof.

Optionally, the molecules to be released are of any size, and are preferably hydrophilic. However, in an embodiment, the one or more molecules released by the materials of the present invention comprise one or more small-molecule compounds. As used herein, “small molecules” and “small-molecule compounds” refer to compounds having a molecular weight of approximately 900 daltons or less, preferably approximately 700 daltons or less, preferably approximately 500 daltons or less, or preferably approximately 300 daltons or less. In an embodiment, the one or more molecules to be released comprise proteins, peptides, saccharides, nucleic acids, plasmid DNA, biologics, small molecules, or combinations thereof.

In an embodiment, the porous matrix comprises a multilayer film having two or more layers, wherein each layer comprises a first polymer in contact with a second polymer, and said multilayer film has nanoscale or microscale porosity. In an embodiment, the porous matrix comprises a slippery liquid-infused porous surface (SLIPS) or slippery nanoemulsion-infused porous surface (SNIPS) fabricated by the infusion of a lubricating liquid or emulsion into microporous or nanoporous multilayer film, where the multilayer film comprises one or more degradable or biocompatible polymers. Methods of fabricating suitable multilayer films by reactive/covalent layer-by-layer assembly are described in Manna et al., Adv. Mater. 2015, 27, 3007; Buck et al., Adv. Mater. 2007, 19, 3951; Buck et al., Polym. Chem. 2012, 3, 66; and Manna et al., Adv. Funct. Mater. 2015, 25, 1672.

The first and second polymers can comprise any polymers or combination of polymers able to form stable multilayer films and where the first polymer is optionally able to be functionalized and the second polymer is optionally also able to be functionalized (as described in U.S. Pat. No. 8,071,210). The chemical reactivity of the functionalized polymers provides means to tune interactions between the matrix and infused emulsion phases. Spatial control over the functionalization can be used to create SLIPS with regions devoid of emulsion that can prevent or arrest the sliding of aqueous fluids, extract samples of liquid from contacting media, or provide control over the trajectories of sliding droplets. Preferably, the first polymer is covalently cross-linked with the second polymer. In further embodiments, the polymers are reacted with small chemical groups containing a hydrophobic or hydrophilic amine to further functionalize the polymers (i.e., to install secondary surface functionality).

In an embodiment, materials useful for generating the materials in the present invention include homopolymers and copolymers of natural and synthetic monomers. In certain embodiments the polymer or polymers are degradable, including but not limited to degradable polyesters, degradable polyanhydrides, degradable polyorthoesters, hydrolytically degradable polymers, and combinations thereof. Examples of materials that are useful for the invention include, but are not limited, to homopolymers and copolymers comprising polylactide, polyglycolide, poly(lactic-co-glycolic acid), polycaprolactone, poly(sebacic acid), and combinations thereof.

Optionally, one or more of the polymers may be biocompatible, although not readily degradable, including but not limited to certain polyamides, polyesters, polyvinyls, polycarbonates, polyanhydrides, polyorthoesters, polyurethanes, polyacrylates, polyketones, polyacetals, and combinations thereof. Additional examples of materials that are useful for the invention include, but are not limited, to homopolymers and copolymers comprising polyvinyl chloride (PVC), polycarbonate, polytetrafluoroethylene (PTFE), poly(methyl methacrylate), PDMS, polystyrene (PS), polyvinylidene difluoride (PVDF), polyethylene, polybutadiene, functionalized azlactones, and combinations thereof. In an embodiment, at least 20% of the polymers within the porous matrix (by weight) are degradable polymers (including but not limited to polylactide, polyglycolide, polycaprolactone, poly(sebacic acid), combinations thereof), preferably at least 30%, preferably at least 40%, preferably at least 50%, preferably at least 60%, preferably at least 70%, preferably at least 80%, preferably at least 90%, or preferably at least 95%.

In an embodiment, the first polymer comprises functionalized azlactone polymers including, but not limited to, poly(vinyl-4,4-dimethylazlactone), poly(2-vinyl-4,4-dimethyl-2-oxazolin-5-one), poly(2-isopropenyl-4,4-dimethyl-2-oxazolin-5-one), poly(2-viny 1-4,4-diethy 1-2-oxazolin-5-one), poly(2-vinyl-4-ethyl-4-methyl-2-oxazolin-5-one), poly(2-vinyl-4-dodecyl-4-methyl-2-oxazolin-5-one), poly(2-vinyl-4,4-pentamethylene-2-oxazolin-5-one), poly (2-vinyl-4-methyl-4-phenyl-2-oxazolin-5-one), poly(2-isopropenyl-4-benzyl-4-methyl-2-oxazolin-5-one), or poly(2-vinyl-4,4-dimethyl-1,3-oxazin-6-one). In an embodiment, the first polymer is a copolymer having degradable ester linkages synthesized by the copolymerization of a vinyl azlactone functionalized monomer and the cyclic ketene acetal 2-methylene-1,3-dioxepane. Useful azlactone functionalized polymers further include azlactone functionalized polyisoprenes and azlactone functionalized polybutadienes.

In an embodiment, the second polymer is optionally functionalized and comprises an amine functionalized polymer, an alcohol functionalized polymer, or a thiol functionalized polymer. Creating specific functionalities with amine, alcohol, and thiol groups is a process well known in the art (for example, see Bioconjugate Techniques, 2nd Edition, 2008, Greg T. Hermanson). In embodiments, the second polymer comprises an optionally functionalized polymer selected from the group consisting of poly(ethylene imine) (PEI), polylysine, pollyallylamine, poly(amidoamine) dendrimers, polyvinyl alcohol, poly hydroxyl ethyl methacrylate, poly(methacrylic acid) functionalized with cysteamine, and linear and hyperbranched and dendritic polymers functionalized with primary amines, hydroxyl groups, or thiol groups.

In embodiments, the second polymer comprises a polymer, which is optionally functionalized, selected from the group consisting of polyolefins, poly(alkyls), poly(alkenyls), poly(ethers), poly(esters), poly(imides), polyamides, poly(aryls), poly(heterocycles), poly(ethylene imines), poly(urethanes), poly(α,β-unsaturated carboxylic acids), poly(α,β-unsaturated carboxylic acid derivatives), poly(vinyl esters of carboxylic acids), poly(vinyl halides), poly(vinyl alkyl ethers), poly(N-vinyl compounds), poly(vinyl ketones), poly(vinyl aldehydes) and any combination thereof. In an embodiment, the second polymer comprises poly(ethylene imine) (PEI).

For some embodiments, it may be desirable to further functionalize a portion of the film formed by the polymers. This can be achieved, for example, by reacting a portion of any residual functional groups in the polymers with an amine group or hydroxyl group, or by reacting a portion of the first or second polymer with an amine reactive group or hydroxyl reactive group.

In an embodiment, the present invention provides a method of fabricating a multilayer film comprising the steps of: exposing a surface of the substrate to a first solution comprising a first polymer wherein the first polymer is deposited on at least a portion of the substrate; and exposing the substrate to a second solution comprising a second polymer wherein the second polymer reacts with the first polymer and the second polymer is deposited on at least a portion of the first polymer. This process is performed one or more times to form the multilayer film. The lubricating liquid or emulsion coats at least a portion of the multilayer film and least partially fills the pores of at least a portion of said multilayer film.

Preferably, the first and second polymer solution are repeatedly added one or more times until the multilayer film reaches the desired thickness or desired number of layers before the substrate is exposed to the lubricating fluid or emulsion, where each cycle deposits a new layer on the substrate. In specific embodiments, the multilayer polymer film comprises more than two layers. In a further embodiment, steps a) and b) are repeated 2 or more times, 5 or more times, 10 or more times, 20 or more times, 30 or more times, 50 or more times, or 100 or more times. The substrate can be exposed to the solutions containing the polymer solutions using methods known in the art, including but not limited to dip coating and spraying techniques.

The fabrication method relating to the multilayer film optionally comprises a rinsing step comprising exposing or washing the substrate with a rinse solvent or solution each time the first polymer solution is added and each time step the second polymer solution is added. In an embodiment, a fresh rinse solvent or solution is employed for each rinsing step. In a further embodiment, the same rinse solution is re-used for each rinsing step.

One aspect of the invention provides thin multilayer polymer films and coatings (e.g., equal to or less than 100 μm, equal to or less than 50 μm, preferably less than or equal to 10 μm, preferably less than or equal to 5 μm). Preferably, the multilayer film comprises 2 or more layers, 5 or more layers, 10 or more layers, 20 or more layers, 30 or more layers, 50 or more layers, or 100 or more layers. Preferably the first polymer forms one or more first polymer layers that alternate with one or more second polymer layers. In embodiments, the multilayer films have nanoscale or microscale porosity. Preferably, the multilayer films have nanoscale porosity.

In an embodiment, the present invention provides a method for fabricating anti-fouling materials as described above comprising the steps of: a) forming a porous matrix on a substrate, wherein the porous matrix comprises one or more degradable polymers, one or more biocompatible polymers, one or more degradable linkers, or combinations thereof; and b) exposing the porous matrix to a lubricating liquid or emulsion, wherein the lubricating liquid or emulsion coats at least a portion of the porous matrix and the lubricating liquid or emulsion at least partially fills the pores of at least a portion of said porous matrix, wherein the lubricating liquid or emulsion comprises a vegetable oil, seed oil or other oil, thereby forming an anti-fouling material on the substrate. Optionally, at least 5%, at least 10%, at least 20%, at least 30%, at least 50%, or at least 60% of the material (by weight) is able to degrade within a 12 month period of time. In an embodiment, the porous matrix is a degradable porous matrix. Preferably, forming the porous matrix comprises electrospinning or blow spinning a nanofiber-based mesh.

The method may further comprise the step of loading one or more molecules onto the porous matrix and/or into the lubricating liquid or emulsion. In certain embodiments, the one or more molecules are biologically or pharmaceutically active agents. Preferably, the one or more molecules are able to reduce, inhibit, or modulate the behaviors of microorganisms in a surrounding environment containing the anti-fouling material. In an embodiment, the non-adherent pathogens are bacteria, fungi, or a combination thereof. Optionally, the one or more molecules are antimicrobial agents, antifungal agents, antibacterial agents, agents that modulate bacterial or fungal quorum sensing, agents that attenuate virulence, or combinations thereof.

In an embodiment, the present invention provides a method for preventing or reducing fouling of a substrate comprising depositing an anti-fouling degradable material on a substrate, where the material comprises a) a porous matrix comprising one or more degradable polymers, one or more biocompatible polymers, one or more degradable linkers, or combinations thereof; and b) a lubricating liquid or emulsion covering a first surface of the porous matrix. Preferably, the lubricating liquid or emulsion at least partially fills the pores of the porous matrix and allows other liquids and compounds to contact the degradable material without adhering to the degradable material. In an embodiment, the lubricating liquid or emulsion at least partially fills pores of the porous matrix and allows other liquids and compounds, particularly fouling liquids, compounds, substances and microorganisms, to slide off the first surface without adhering to the first surface. In an embodiment, the fouling liquids, compounds, substances and microorganisms are able to slide off the first surface with a sliding angle of 50° or less, 40° or less, 30° or less, 20° or less, 10° or less, 5° or less, 2.5° or less, or 2° or less. In an embodiment, the porous matrix is a degradable porous matrix. Preferably, the porous matrix is generated by electrospinning or blow spinning.

Substrates suitable for use with the present invention can include any material able to support the formation of the porous matrix, including but not limited to glass, metals and plastics. The substrate can include curved and irregularly shaped three-dimensional surfaces, as well as completely solid surfaces and mesh surfaces (e.g., having a porosity between 100 μm and 250 μm). For example, the substrate can be the interior of a tube or container for a liquid or gel where it is undesirable for the contents of the tube or container to stick or adhere to the surface, such as a packaging material or the surface of a container meant to contain foods or other consumer products. Other examples include medical devices used to transport a substance to or from or within a patient's body. The porous matrix, first polymer, second polymer, and lubrication liquid and emulsion are therefore selected so that the liquid or gel has reduced adhesion to the container or device. Alternatively, the substrate can be a display of a sensor where the degree or extent to which a liquid adheres to the substrate indicates the presence of a substance in the liquid.

The methods described herein can be used to fabricate physically and chemically durable materials and coatings on objects of arbitrary shape, size, and topology (e.g., on curved surfaces, insides of hollow tubes, etc.). Specifically these slippery surfaces could be used as anti-fouling surfaces, anti-bacterial/fungal surfaces where the lubricating liquid, emulsion, or polymer matrix is used to release of other active agents (e.g., antibiotics, antimicrobial agents, anti-biofilm agents, and other biologically or pharmaceutically active compounds) that can reduce or inhibit non-adherent pathogens in the surrounding media.

### BRIEF DESCRIPTION OF THE DRAWINGS

FIG. 1: Panel A) Schematic showing the electrospinning-based approach used to fabricate degradable nanofiber-based SLIPS. The structure of PCL is also shown. Panels B,C) Low-and high magnification top-down (B) and cross-sectional (C) SEM images of PCL-nanofiber meshes fabricated by electrospinning; scale bar of inset in B is 500 nm. D) Droplets of water and chemically complex liquids sliding down SLIPS-coated strips of Al foil; droplets were 20 μL and tilt angle was 20°; the water contained a pink dye.

FIG. 2: Panels A-F) Fluorescence microscopy images of bare and SLIPS-coated substrates after incubation in suspensions of C. albicans (A,B) E. coli (C,D), and S. aureus (E,F) for 24 h; C. albicans samples were stained with FUN-1 fluorescent dye and E. coli and S. aureus samples were stained with SYTO-9 dye prior to imaging. G,H) Fluorescence microscopy images of bare glass and SLIPS-coated glass substrates after incubation with 3T3 cells for 48 h; samples were stained with SYTO-9 prior to imaging. Scale bars are 200 μm in (A,B), 400 μm in (C-F), and 100 μm in (G-H).

FIG. 3: Panel A) Top-down images showing a droplet of blood (20 μL; tilt angle≈20°) sliding on a silicone oil-infused SLIPS surface (˜4×1 cm). B) Images of PCL nanofiber-coated substrates (non-infused (left strip), silicon oil-infused (middle strip), and olive oil-infused (right strip)) before and after dipping in blood multiple times; time-series images are shown for the first cycle only. C-E) SEM images of platelet adhesion on (C) bare glass, (D) PCL nanofiber-coated glass with no infused oil, and (E) SLIPS-coated substrates.

FIG. 4: Panel A) Illustration showing the solution blow spinning approach used to fabricate PCL nanofiber-based mats. B,C) Low- and high-magnification SEM images of PCL mats fabricated by blow spinning a 5 wt % solution of PCL in dichloromethane; see FIG. 7 for additional characterization. D) Images showing contact angle hysteresis (θhys) of a mat that was not infused with oil (left) and mats that were infused with silicone, olive, corn, and almond oil (right). The tilt angles (θtilt) shown are 90° for the non-infused sample, 10° for the silicone, corn, and almond oil-infused substrates, and 5° for the olive oil-infused substrate. E) Images showing droplet of aqueous TMR (30 μL; tilt angle≈20°) sliding on a 4 cm long silicone oil-infused degradable SLIPS coating fabricated by blow spinning.

FIG. 5: Panels A-J) Images of objects coated with PCL nanofiber mats fabricated using blow spinning: (A) watch glass, (B) rubber nitrile glove, (C) polycarbonate safety glasses, (D) banana, and (E) a strip of double-sided adhesive tape. Panels (F-J) show the same objects after infusion with silicone oil. (K-P) Images of an uncoated gloved finger (K-M) and a SLIPS-coated gloved finger (N-P) upon immersion and removal from a sample of ketchup. Q-V) Images of an uncoated watch glass (Q-S) and a SLIPS-coated watch glass (T-V) upon exposure to and draining of blood. W) Image showing a strip of SLIPS-coated adhesive tape applied to the surface of a glass slide; the edges of the SLIPS-coated tape are marked with dashed lines to guide the eye. The image in (X) shows the same surface in (W) after splashing the entire surface with red water-based paint; the area of the substrate coated with the slippery tape remained clean.

FIG. 6: Panel A) Plot showing release of TMR from TMR-loaded PCL mats upon incubation in PBS buffer at 37° C. Symbols correspond to coatings that do not contain infused oil (▴) and coatings that are infused with silicone oil (u=50 cSt (♦) or 500 cSt (▪)). The symbol (▾) corresponds to the release profile of mats infused with silicone oil (u=500 cSt) incubated at 4° C. During some experiments using mats infused with silicone oil (50 cSt), 10 mg/mL SDS was introduced at the time point marked by the arrow; the results of these experiments are indicated with closed circles (●) and a dotted line. B) Plot showing release of TMR from TMR-loaded PCL mats infused with olive oil (▴) and not infused with oil (●) upon incubation in PBS buffer at 37° C. Error bars denote standard deviations and in some cases are smaller than the symbols.

FIG. 7: Histogram showing the distribution of fiber diameters for samples of electrospun PCL nanofibers alone (no TMR; top; mean diameter=404±170 nm) and TMR-loaded electrospun PCL nanofibers (second from top; mean diameter=308±139 nm) and blowspun PCL nanofibers alone (no TMR; second from bottom; mean diameter=193±87 nm) and TMR-loaded blowspun PCL nanofibers (bottom; mean diameter=288±105 nm).

FIG. 8: Fluorescence microscopy images of the surfaces of bare glass and olive oil-infused SLIPS-coated glass substrates after incubation in suspensions of S. aureus for 24 h; S. aureus samples were stained with SYTO-9 green-fluorescent nucleic acid stain prior to imaging. Scale bars are 400 μm.

FIG. 9: Panel A) Top-down SEM image of electrospun PCL nanofibers loaded with TMR. Refer to FIG. 7 for characterization of the nanofiber size distribution. B-D) Representative fluorescence microscopy images of electrospun PCL nanofibers loaded with TMR before (B) and after infusion with silicone oil with a viscosity of either 50 cSt (C) or 500 cSt (D).

FIG. 10: Panel A-B) Top-down SEM (A) and fluorescence microscopy (B) images of blow spun PCL nanofibers loaded with TMR. Scale bar of inset=500 nm. Refer to FIG. 7 for characterization of the nanofiber size distribution. The arrows point toward non-uniformities, primarily consisting of polymeric aggregates and beads seen in the blow spun TMR-loaded meshes. C) Series of images showing water droplets (10 μL) sliding on an olive oil-infused TMR-loaded PCL nanofiber mesh fabricated by blow spinning (θtilt˜10°). D) Plot showing the release of TMR from TMR-loaded (loading amount=3.79±0.31 μg cm⁻²) ‘dry’ (●) and olive oil-infused (▴) nanofiber-based meshes upon incubation in PBS at 37° C.

FIG. 11: Images showing zones of inhibition, or areas of no or little bacterial growth, surrounding poly(caprolactone)-based SLIPS containing the antimicrobial agent (Panel A) triclosan or (Panel B) ciprofloxacin. Images were acquired 24 hours after the placement of degradable SLIPS onto agar plates inoculated with either S. aureus (A) or P. aureginosa (B). Zones of inhibition appear as lighter or brighter ‘halos’ surrounding the rectangular SLIPS-coated glass substrates.

### DETAILED DESCRIPTION OF THE INVENTION

### Definitions

As used herein, a nanofiber refers to a fiber having a diameter in the nanometer range. A mesh, mat, or matrix of the present invention may contain nanofibers generated from the same or different polymers.

As used herein, an emulsion refers to a mixture of two or more liquids that are normally immiscible. For example, emulsions can include an oil-in-water emulsion, wherein the oil is the dispersed phase, and water is the continuous phase, as well as water-in-oil emulsion where water is the dispersed phase and the oil is the continuous phase. In an emulsion, one liquid (the dispersed phase) is dispersed in the other liquid (the continuous phase) often in the form of droplets.

As used herein, the term “hydrophilic” refers to a molecule or substance attracted to water, or able to form ionic or hydrogen bonds with polar solvents, in particular with water, or with polar groups. The term “hydrophobic” refers to a molecule or substance that repels water or that is insoluble in water.

As used herein, the term “slippery” refers to surfaces that allow liquid droplets and other compounds to slide off the surface with sliding angles of 90° or less, 70° or less, 50° or less, 40° or less, 30° or less, 20° or less, 10° or less, preferably 5° or less, 2.5° or less, or 2° or less.

As used herein, the term “controllably released” refers to a molecule, drug and/or compound that is initially contained within the porous matrix, and/or lubricating liquid, and/or emulsion and is progressively released into the surrounding media over a consistent period of time. In some embodiments, the time required to release at least 50% of the molecule, drug and/or compound into the surrounding media is 6 hours or more, preferably 24 hours or more, 4 days or more, preferably 10 days or more, 20 days or more, 30 days or more, 60 days or more, 100 days or more, 120 days or more, or 180 days or more.

As used herein, “functionalized polymer” refers to a polymer in which at least a portion of the individual monomer units are substituted with a specific functional group. For the functionalized polymers of the present invention, at least 1% or more, at least 2% or more, at least 5% or more, at least 10% or more, at least 15% or more, at least 20% or more, at least 30% or more, at least 50% or more, at least 75% or more, or at least 90% or more of the portion of the monomer units is substituted with a specific functional group.

An “amine reactive group” or “hydroxyl reactive group” can be any functional group able to react with an amine group or hydroxyl group, respectively.

As used herein, the term “anti-fouling” refers to a material's ability to resist adhesion by an undesirable material, such as oils, organic compounds, and organisms. In particular, it is desirable to prevent or reduce the adhesion of hydrophobic compounds and organisms to a material that is submerged or in contact with water.

The term “nanoscale” refers to a length less than 1,000 nm, preferably less than 100 nm, and the term “microscale” refers to a length less than 1,000 μm, preferably less than 100 μm.

The term “alkyl” refers to a monoradical of a branched or unbranched (straight-chain or linear) saturated hydrocarbon and to cycloalkyl groups having one or more rings. Alkyl groups as used herein include those having from 1 to 20 carbon atoms, preferably having from 1 to 12 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-20 carbon atoms. Cycloalkyl groups include those having one or more rings. Cyclic alkyl groups include those having a 3-, 4-, 5-, 6-, 7-, 8-, 9-, 10-, 11- or 12-member carbon ring and particularly those having a 3-, 4-, 5-, 6-, or 7-member ring. The carbon rings in cyclic alkyl groups can also carry alkyl groups. Cyclic alkyl groups can include bicyclic and tricyclic alkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxy group is an alkyl group linked to oxygen and can be represented by the formula R-O. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups.

The term “alkenyl” refers to a monoradical of a branched or unbranched unsaturated hydrocarbon group having one or more double bonds and to cycloalkenyl groups having one or more rings wherein at least one ring contains a double bond. Alkenyl groups include those having 1, 2 or more double bonds and those in which two or more of the double bonds are conjugated double bonds. Alkenyl groups include those having from 2 to 20 carbon atoms, preferably having from 2 to 12 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those having one or more rings. Cyclic alkenyl groups include those in which a double bond is in the ring or in an alkenyl group attached to a ring. Cyclic alkenyl groups include those having a 3-, 4-, 5-, 6-, 7-, 8-, 9-, 10-, 11- or 12-member carbon ring and particularly those having a 3-, 4-, 5-, 6- or 7-member ring. The carbon rings in cyclic alkenyl groups can also carry alkyl groups. Cyclic alkenyl groups can include bicyclic and tricyclic alkyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogens replaced with one or more fluorine atoms.

The term “aryl” refers to a chemical group having one or more 5-, 6- or 7-member aromatic or heterocyclic aromatic rings. An aromatic hydrocarbon is a hydrocarbon with a conjugated cyclic molecular structure. Aryl groups include those having from 4 to 30 carbon atoms, preferably having from 6 to 18 carbon atoms. Aryl groups can contain a single ring (e.g., phenyl), one or more rings (e.g., biphenyl) or multiple condensed (fused) rings, wherein at least one ring is aromatic (e.g., naphthyl, dihydrophenanthrenyl, fluorenyl, or anthryl). Heterocyclic aromatic rings can include one or more N, O, or S atoms in the ring. Heterocyclic aromatic rings can include those with one, two or three N, those with one or two O, and those with one or two S, or combinations of one or two or three N, O or S. Aryl groups are optionally substituted. Substituted aryl groups include among others those which are substituted with alkyl or alkenyl groups, which groups in turn can be optionally substituted. Specific aryl groups include phenyl groups, biphenyl groups, pyridinyl groups, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocylic aromatic group-containing groups corresponding to any one of the following benzene, naphthalene, naphthoquinone, diphenylmethane, fluorene, fluoranthene, anthracene, anthraquinone, phenanthrene, tetracene, naphthacenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic radical, including monovalent, divalent and polyvalent radicals, of the aromatic and heterocyclic aromatic groups listed above provided in a covalently bonded configuration in the compounds of the present invention. Aryl groups optionally have one or more aromatic rings or heterocyclic aromatic rings having one or more electron donating groups, electron withdrawing groups and/or targeting ligands provided as substituents.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl having one or more hydrogens replaced with one or more fluorine atoms, chlorine atoms, bromine atoms and/or iodine atoms.

Optional substitution of any alkyl, alkenyl and aryl groups includes substitution with one or more of the following substituents: halogens, —CN, —COOR, —OR, —COR, —OCOOR, —CON(R)₂, —OCON(R)₂, —N(R)₂, —NO₂, —SR, —SO₂R, —SO₂N(R)₂ or —SOR groups. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for alkyl and alkenyl groups include among others:
—COOR where R is a hydrogen or an alkyl group or an aryl group and more specifically where R is methyl, ethyl, propyl, butyl, or phenyl groups all of which are optionally substituted;
—COR where R is a hydrogen, or an alkyl group or an aryl groups and more specifically where R is methyl, ethyl, propyl, butyl, or phenyl groups all of which groups are optionally substituted;
—CON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;
—OCON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;
—N(R)₂ where each R, independently of each other R, is an alkyl group, acyl group or an aryl group and more specifically where R is methyl, ethyl, propyl, butyl, or phenyl or acetyl groups all of which are optionally substituted; or R and R can form a ring which may contain one or more double bonds.
—SR, —SO₂R, or —SOR where R is an alkyl group or an aryl groups and more specifically where R is methyl, ethyl, propyl, butyl, phenyl groups all of which are optionally substituted; for —SR, R can be hydrogen;
—OCOOR where R is an alkyl group or an aryl groups;
—SO₂N(R)₂ where R is a hydrogen, an alkyl group, or an aryl group and R and R can form a ring;
—OR where R is H, alkyl, aryl, or acyl; for example, R can be an acyl yielding —OCOR* where R* is a hydrogen or an alkyl group or an aryl group and more specifically where R* is methyl, ethyl, propyl, butyl, or phenyl groups all of which groups are optionally substituted.

As used herein, the term “alkylene” refers to a divalent radical derived from an alkyl group or as defined herein. Alkylene groups in some embodiments function as attaching and/or spacer groups in the present compositions. Compounds of the present invention include substituted and unsubstituted C₁-C₃₀ alkylene, C₁-C₁₂ alkylene and C₁-C₅ alkylene groups. The term “alkylene” includes cycloalkylene and non-cyclic alkylene groups.

As used herein, the term “cycloalkylene” refers to a divalent radical derived from a cycloalkyl group as defined herein. Cycloalkylene groups in some embodiments function as attaching and/or spacer groups in the present compositions. Compounds of the present invention include substituted and unsubstituted C₁-C₃₀ cycloalkenylene, C₁-C₁₂ cycloalkenylene and C₁-C₅ cycloalkenylene groups.

As used herein, the term “alkenylene” refers to a divalent radical derived from an alkenyl group as defined herein. Alkenylene groups in some embodiments function as attaching and/or spacer groups in the present compositions. Compounds of the present invention include substituted and unsubstituted C₁-C₂₀ alkenylene, C₁-C₁₂ alkenylene and C₁-C₅ alkenylene groups. The term “alkenylene” includes cycloalkenylene and non-cyclic alkenylene groups.

As used herein, the term “cycloalkenylene” refers to a divalent radical derived from a cylcoalkenyl group as defined herein. Cycloalkenylene groups in some embodiments function as attaching and/or spacer groups in the present compositions.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

As used herein, the term “halo” refers to a halogen group such as a fluoro (—F), chloro (—CI), bromo (—Br) or iodo (—I).

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

### Overview

Surface-associated fouling by bacteria is a common and persistent challenge facing the use of biomedical devices, industrial equipment, and many consumer products. Additionally, it is highly desirable that such materials and products be degradable, non-toxic, and sustainable. The development of environmentally compatible materials is an important element in the design of anti-fouling materials and coatings.

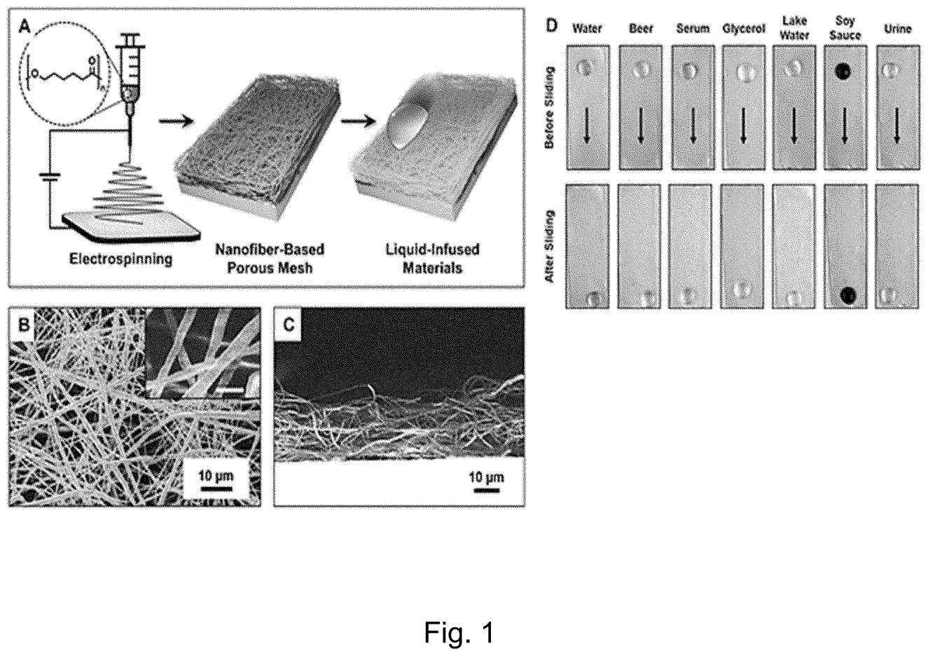

The biocompatible and degradable SLIPS described here are generally based on the infusion of slippery liquids, emulsions, or oils, into nanofiber-based matrices or meshes, such as those fabricated by the electrospinning or blow spinning. This approach is illustrated schematically in FIG. 1, panel A, and was initially selected for several reasons. Firstly, electrospinning and blow spinning are both well-developed technologies that can be used to create polymer matrices (or ‘mats’) with interconnected, 3-D porous structures and high internal surface areas that can trap and host secondary liquid phases (Pham et al., Tissue Eng. 2006, 12: 1197-1211; Teo et al., Nanotechnology 2006, 17: R89-R106; Daristotle et al., ACS Appl. Mater. Interfaces 2016, 8: 34951-34963; and Gao et al., Materials Horizons 2021, 8: 426-446). Secondly, degradible and biocompatible polymers, including but not limited to poly(ε-caprolactone) (PCL), are readily-available and have been used extensively in surgical implants and drug delivery devices (Woodruff et al., Prog. Polym. Sci. 2010, 35: 1217-1256.). Thirdly, many degradible and biocompatible polymers are hydrophobic, exhibit good water resistance, and degrade very slowly in many aqueous environments, providing a matrix that is hypothesized to be useful for the infusion and stable retention of hydrophobic oils without the need for additional chemical functionalization or the synthesis of new chemically compatible building blocks.

The experimental results provided below reveal that degradible polymer mats can be infused to generate SLIPS using a broad range of oils, including synthetic oils, such as silicone oil, and edible oils, such as corn, olive, and almond oils. Both food oils and silicone oil are used as models in the work described below. The use of silicone oil enables manipulation of liquid-phase viscosities in fundamental studies and is used widely for the design of conventional SLIPS, permitting comparisons to other liquid-infused materials. Additionally, SLIPS generated by infusion of food oils into degradible polymer mats can be comprised entirely of biodegradable and/or edible components.

The Examples below describe the fabrication and characterization of degradable SLIPS using degradible polymer mats fabricated by electrospinning. The characterization of processes based on blow spinning are also detailed in subsequent sections.

### Example 1

Fabrication of Degradable SLIPS Using Electrospun PCL Mats

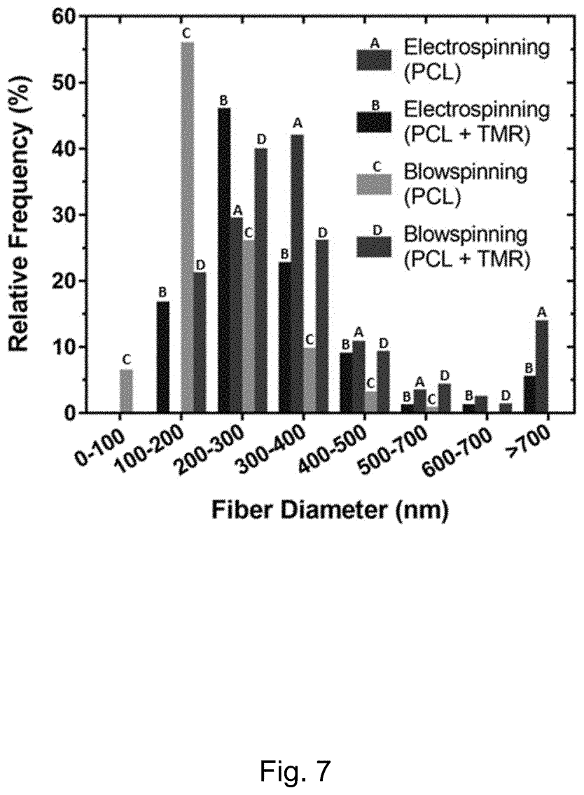

FIG. 1, panel B, shows representative SEM images of porous PCL nanofiber mats fabricated under the conditions used here to design oil-infused surfaces (see Example 5 for details of electrospinning parameters). These images reveal these materials to be composed of a network of randomly aligned nanofibers that are largely devoid of structural defects or features such as beads or flattened areas (average diameter ˜400 nm; see FIG. 7 for additional characterization). The thicknesses of these mats can be varied readily as a function of electrospinning time; cross-sectional SEM images of mats formed by electrospinning for ˜5 min reveal them to have average thicknesses of ˜40 μm (FIG. 1, panel C). Inspection of these images also reveals the porosity observed in the top-down SEM images shown in FIG. 1, panel B, to be present throughout the bulk of these materials, consistent with the internal morphologies of PCL nanofiber mats reported in past studies (Pham et al., Tissue Eng. 2006, 12: 1197-1211; and Cipitria et al., J. Mater. Chem. 2011, 21: 9419-9453) and essential for the design of robust liquid-infused surfaces (Solomon et al., Non-wettable Surfaces: Theory, Preparation and Applications, The Royal Society of Chemistry, 2017, pp. 285-318; and Villegas et al., ACS Nano 2019, 13: 8517-8536).

These electrospun PCL mats can be infused with hydrophobic liquids to create surfaces that are both ‘slippery’ and anti-fouling to a broad range of chemically complex liquids. Drops of silicone oil placed on the surfaces of these porous meshes readily spread across the surfaces of the mats (θ˜0°) and infused into the mesh (evident from changes in visual appearance from opaque to transparent after oil infusion). Aqueous droplets placed on ‘dry’ (non-oil-infused) PCL mats wet the surface of the mat and did not roll or slide off, even at substrate tilt angles as high as 90°. In contrast, droplets of water placed on oil-infused coatings slid off unimpeded (see FIG. 1, panel D).

FIG. 1, panel D, shows top-down views of 20 μL droplets of a range of other chemically complex liquids, including beer, serum, glycerol, lake water, soy sauce, and human urine on silicone oil-infused SLIPS tilted at 20°. Droplets of these liquids slid off the surfaces of these substrates (˜4 cm) over a period of 5-10 s. These substrates could be subjected to liquids repeatedly without observable erosion of slippery behavior; additional characterization of other aspects of physical and chemical robustness is described below.

As noted above, these porous PCL meshes can also be infused with a broad range of other oils, including food oils that are edible and biodegradable, such as corn, olive, and almond oils. Table 1 shows advancing water contact angles (θadv), contact angle hysteresis (θhys), and sliding angles (θs) of 10 μL water droplets placed on PCL mats infused with silicone, corn, olive, and almond oils. In each of these cases, aqueous droplets slid at low sliding angles (<10°) and exhibited θhys <10°, demonstrating the robust slippery behaviors of these liquid-infused surfaces. In particular, olive oil-infused surfaces exhibited contact angle hysteresis and sliding angles that were significantly lower (θhys <2° and θs˜5°) than those of the other oils used in this study. These differences in sliding behaviors are consistent with differences in the configurations of the oil-water interfaces formed when aqueous droplets are placed on liquid-infused surfaces (Smith et al., Soft Matter 2013, 9: 1772-1780; and Preston et al., ACS Appl. Mater. Interfaces 2017, 9: 42383-42392).

TABLE 1
Impact of Infused Oil on Sliding Behavior

| Infused- | | | |
|---|---|---|---|
| Liquid | Θ_{Adv} (°) | Θ_{hys} (°) | θₛ(°) |
| Silicone | 93 ± 3 | 6 ± 1 | 9 ± 2 |
| Corn | 65 ± 5 | 8 ± 1 | 10 ± 2 |
| Olive | 82 ± 2 | <2 | 5 ± 2 |
| Almond | 82 ± 3 | 5 ± 1 | 10 ± 3 |

For olive oil-infused surfaces, Sos(w)=0 (see Table 2), suggesting complete wetting and encapsulation of the porous surface underneath the sliding droplet, resulting in extremely low sliding angles (see Table 1). For silicone oil-infused surfaces, —γowR<Sos(w)<0 (Table 2), indicative of an emergent porous matrix beneath the droplet (i.e., the tops of the porous surface emerge, to some extent, from the infused silicone oil phase and make contact with the sliding droplets), leading to higher sliding angles and contact angle hysteresis.

TABLE 2
Evaluation of the stability of silicone oil- and olive
oil-infused porous nanofiber-based
PCL meshes in the presence of water droplets.

| | Values | Values |
|---|---|---|
| Parameters | (Silicone oil) | (Olive oil) |
| Θ_{ws(a)} (°) | 82 ± 1 | 82 ± 1 |
| Θₒₛ₍ₐ₎ (°) | 0 | 0 |
| γ_{ow} (mN/m) | 36.4 ± 0.6 | 22.4 ± 0.4 |
| γₒₐ (mN/m) | 21.5 ± 0.2 | 21.5 ± 0.2 |
| γ_{wa} (mN/m) | 72.1 ± 0.2 | 72.1 ± 0.2 |
| S_{os(w)} (mN/m) | −24.9 ± 3.3 | 0 |
| R | 0.98 | 0.98 |

Contact angles were measured on a flat smooth PCL surface using 5 μL droplets of water and oil (silicone (η˜50 cSt) or olive) for Θws(a) and Θos(a), respectively. Surface tension (γoa, γwa) and interfacial tension (yow) measurements were performed by the pendant drop method at ambient conditions (temperature=22-24° C. and relative humidity=18-26%). The density of water, silicone oil, and olive oil used for measurements was 0.997 gm/mL, 0.963 gm/mL, and 0.917 gm/mL, respectively. The values denote the mean of three independent measurements, and error denotes the standard deviation. Sos(w)=γoa cos Θos(a)−γwa cos Θws(a)−γow and R=(r−1)/(r−φ); where r is the ratio of the total surface area to the projected area of the solid and φ is the fraction of the projected area of the surface that is occupied by the solid. r is calculated using filament analog model (Liu et al., J. Electrochem. Soc. 2017, 164: A2038-A2048) as (4×(1−ε)×h)/d, where c is the porosity, h is the average cross-sectional thickness, and d is the average diameter of the fibers. ε (=0.127), h (=40 μm), and d (=450 nm) were determined from cross-sectional and top-down SEM images (see FIG. 1). φ was calculated using the Cassie-Baxter model as

$$\frac{cos ( {θ}_{w s ( a )}^{*} ) + 1}{cos ( {θ}_{w s ( a )} ) + 1} . cos ( {θ}_{w s ( a )}^{*} ) ( = 137 ° )$$

was calculated by measuring the angle of 5 μL water droplets on electrospun PCL. The condition for the formation of ‘slippery’ surfaces with emergent posts is −γow R<Sos(w)<0 and the condition for the formation of ‘slippery surfaces with encapsulated posts is Sos(w)≤0.

### Example 2

Anti-Biofouling Properties in Contact with Microorganisms and Physiological Fluids

The ability of these degradable SLIPS-coatings to resist attachment and biofouling (e.g., formation of biofilms) by common fungal and bacterial pathogens were further characterized. Silicone oil-infused SLIPS-coated substrates and bare substrates were incubated in suspensions of Candida albicans (a fungal pathogen), Escherichia coli (a Gram-negative bacterial pathogen), and Staphylococcus aureus (a Gram-positive bacterial pathogen) for 24 h at 37° C.

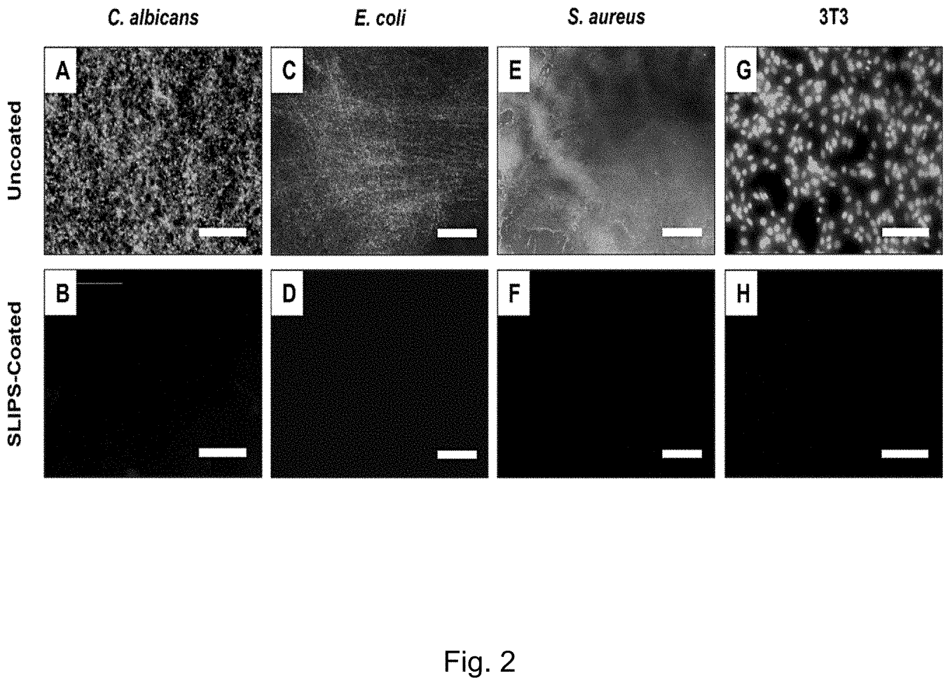

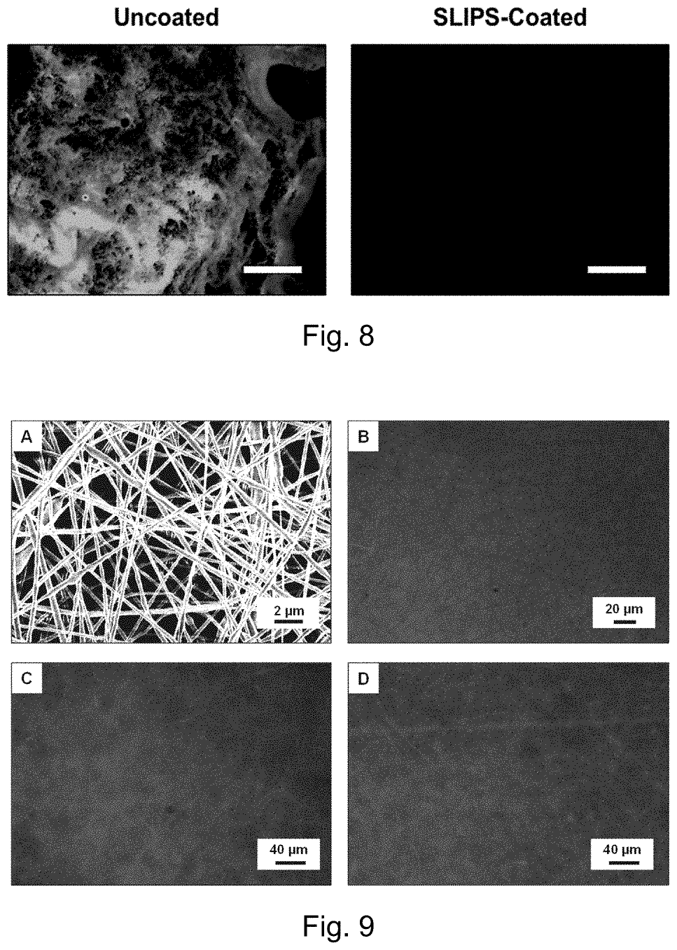

All surfaces were then removed and stained using FUN-1 or SYTO-9 staining solutions to characterize levels of fungal and bacterial biofilms using fluorescence microscopy. FIG. 2, panels A,C,E, reveal the presence of dense biofilms of C. albicans, E. coli, and S. aureus on bare uncoated substrates. In contrast, inspection of the images of SLIPS-coated substrates in FIG. 2, panels B,D,F, reveals the absence of fungal and bacterial biofilms on these slippery surfaces. Olive oil-infused PCL meshes also exhibited robust anti-biofouling performance under these conditions (see FIG. 8). In combination with these microbiological experiments, the ability of these surfaces to prevent fouling by 3T3 cells, a mouse fibroblast cell line widely used as a model in biomedical research, were also characterized. FIG. 2, panels G,H, reveal these SLIPS-coated surfaces to essentially completely prevent fouling after incubation with this mammalian cell line for 24 h.

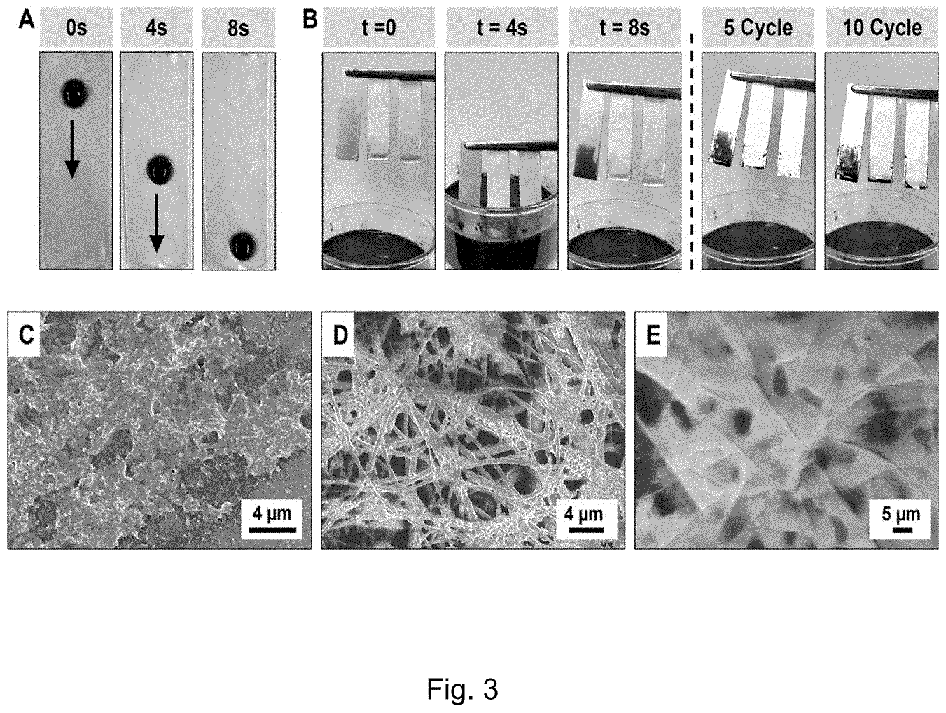

Further investigations showed these degradable SLIPS coatings to repel blood and prevent adhesion of important components of blood involved in clotting and thrombosis. FIG. 3, panel A, shows a 20 μL droplet of fresh pig blood placed on a silicone oil-infused SLIPS surface tilted at 20°; the droplet was observed to slide over a length of 4 cm in ˜8 s; similar sliding behavior was observed on olive oil infused-SLIPS. FIG. 3, panel B, shows a series of images of an uncoated surface (left strip), and silicone oil-infused (middle strip) and olive oil-infused (right strip) SLIPS-coated surfaces after dipping into blood 1, 5, and 10 times. These images reveal both silicone and olive oil infused SLIPS to repel blood after extended and repeated contact.

Finally, FIG. 3, panels C-E, show SEM images of bare glass substrates, nanofiber-coated glass substrates (no oil), and SLIPS-coated substrates after incubation with fresh pig platelet-rich plasma for 1.5 h at 37° C. All of the substrates were then gently washed with PBS, incubated in glutaraldehyde solution to fix adhered platelets, and then dehydrated in a series of ethanol solutions prior to imaging. Inspection of these images reveals dense films of adhered platelets on the bare glass substrate and the nanofiber-coated (no oil) glass substrates. In contrast, SLIPS-coated substrates maintained a stable oil layer, even after exposure of the substrates to a series of dehydration steps in ethanol, and no platelets were observed on the surface (FIG. 3, panel E). The SLIPS-coated substrates also exhibited outstanding hemocompatibility, as indicated by a negligible percentage of hemolysis (˜1%; similar to that observed for uncoated substrates (˜0.9%)) when incubated with human red blood cells.

Overall, these results are broadly consistent with the anti-fouling behaviors and excellent liquid repellency of other non-degradable SLIPS-based materials reported previously. These results are significant because they demonstrate that these salient features and useful behaviors of other oil-infused surfaces, often fabricated using complex and multi-step procedures and oils or matrix materials that are not degradable, can be recapitulated by a straightforward fabrication process using common materials that are biodegradable and biocompatible.

### Example 3

Fabrication of Degradable SLIPS Using Solution Blow Spinning

The overall approach described above for the infusion of oils into PCL mats is also compatible with nanofiber mats fabricated by solution blow spinning (SBS). SBS is an emerging technology for producing polymer nanofibers that addresses or eliminates several practical limitations associated with electrospinning, including the need for high voltages and electrically conductive targets and characteristically low nanofiber production rates (Daristotle et al., ACS Appl. Mater. Interfaces 2016, 8, 34951-34963; and Gao et al., Materials Horizons 2021, 8: 426-446).

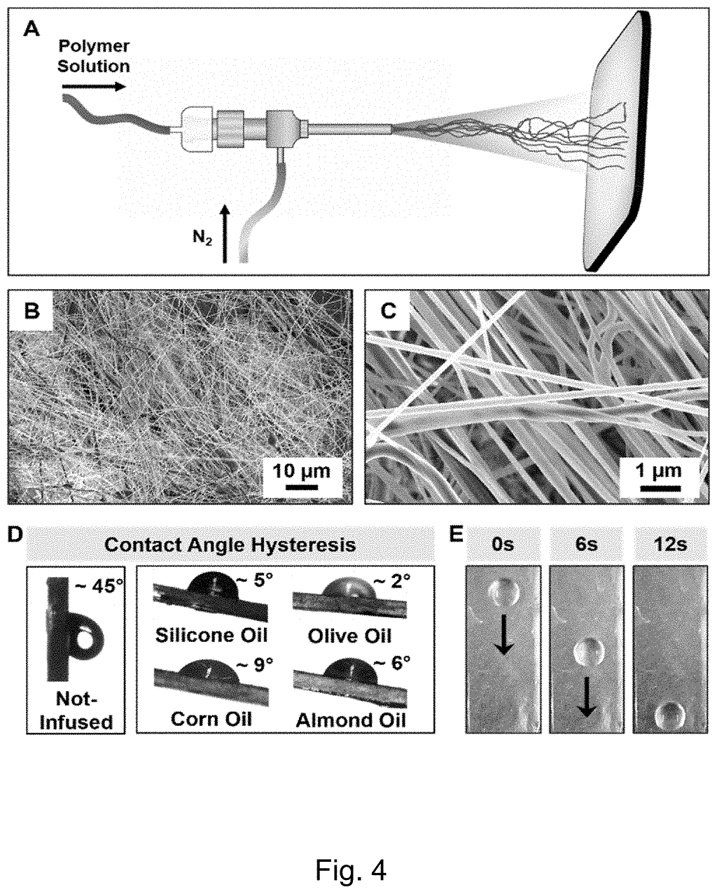

SBS was used to spray PCL solutions of different concentrations (from 5 to 15 wt % in dichloromethane) onto substrates placed ˜6 cm away from the tip of a hand-held blow spinning nozzle (see FIG. 4, panel A). The resulting PCL nanofiber mats exhibited a homogenous nanofiber structure, with an average nanofiber diameter of ˜190 nm and a morphology that was generally free of structural imperfections (FIG. 4, panels B,C, and see FIG. 7 for results of additional characterization of nanofiber size distributions). Infusion of oils into these PCL meshes yielded slippery surfaces that allowed droplets of aqueous solutions to slide off unimpeded. FIG. 4, panel D, shows the contact angle hysteresis for water droplets (10 μL) placed on blow-spun mats infused with silicone, olive, corn, and almond oils. These θhys values were low (<10°) and generally consistent with those described above on SLIPS fabricated by electrospinning. FIG. 4, panel E, shows images of a 30 μL water droplet placed at the upper end of a slippery surface fabricated by blow spinning; the droplet slid down the surface at a rate of ˜3.3 mm s⁻¹.

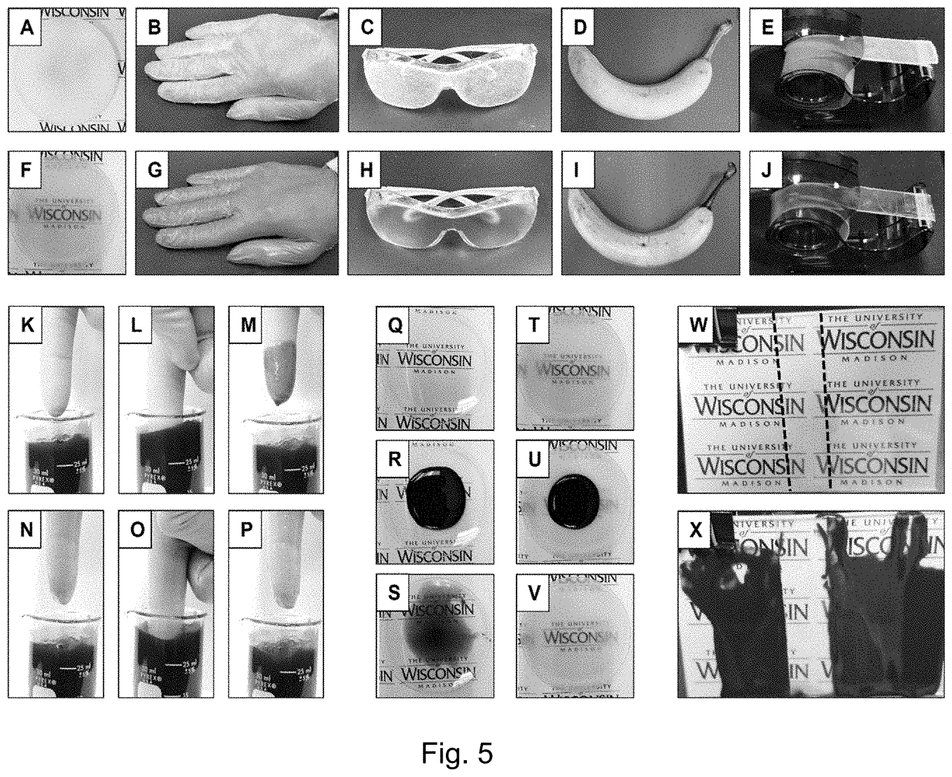

In contrast to electrospinning, blow spinning is rapid, readily scalable, and permits degradable PCL nanofiber mats to be effectively ‘air brushed’ onto objects of arbitrary shape, size, and composition. FIG. 5, panels A-E, shows images of different model substrates, including a watch glass, a rubber glove, polycarbonate safety glasses, a banana, and a strip of adhesive tape that were coated with uniform and conformal PCL nanofiber-based meshes by blow spinning. These objects were selected for these proof-of-concept studies and for demonstration purposes to represent a variety of natural and synthetic surfaces of different shape, size, transparency, and surface characteristics. FIG. 5, panels F-J, shows images of these coated objects after infusion with oil. These degradable coatings generally became transparent after oil-infusion and exhibited slippery properties that were maintained after physical manipulation and exposure to a range of fluids (including repeated immersion in ketchup (see FIG. 5, panels K-P), exposure to blood (see FIG. 5, panels Q-V), and manual rubbing or smudging.

The physically robust nature of the liquid-infused PCL coatings permitted the design of slippery adhesive tape (FIG. 5, panel J) that could be physically transferred to other secondary surfaces to endow them with slippery and anti-fouling properties, as demonstrated in FIG. 5, panels W-X. Overall, these blow spinning strategies for the design of degradable SLIPS offer levels of flexibility and scalability that are more difficult to achieve using electrospinning approaches discussed above and other previously reported SLIPS fabrication procedures.

### Example 4

Incorporation and Release of Small Molecules from Degradable Oil-Infused PCL Mats

These approaches to the design of degradable liquid-infused surfaces also offer means to incorporate or encapsulate molecular cargo into these materials by dissolving or dispersing low-molecular weight agents in the PCL solutions used during fabrication. It was reasoned that, if added agents could be incorporated without substantially altering the surface character of the resulting PCL nanofibers (thereby permitting the stable infusion of oil), this approach could provide new strategies for the design of controlled-release SLIPS and create opportunities for their use in new applied contexts. To explore the feasibility of this approach and establish proof-of-concept, experiments were performed using PCL fibers loaded with 0.5 wt % of the model small-molecule fluorophore TMR. FIG. 9, panel A, shows SEM images of nanofiber mats electrospun from PCL solutions containing TMR and reveals a network of smooth and randomly aligned nanofibers with mean diameters of ˜300 nm (see FIG. 7 for additional characterization of nanofiber size; FIG. 9, panel B, shows a fluorescence microscopy image that reveals red filamentous structures consistent with encapsulation of TMR). Infusion of these loaded PCL mats with silicone oil (u=50 cSt) resulted in slippery coatings with sliding angles of ˜10°, similar to the PCL-based SLIPS coatings without TMR described above (see Table 1; also see FIG. 9, panel C, for fluorescence microscopy images of TMR-loaded oil-infused mats).

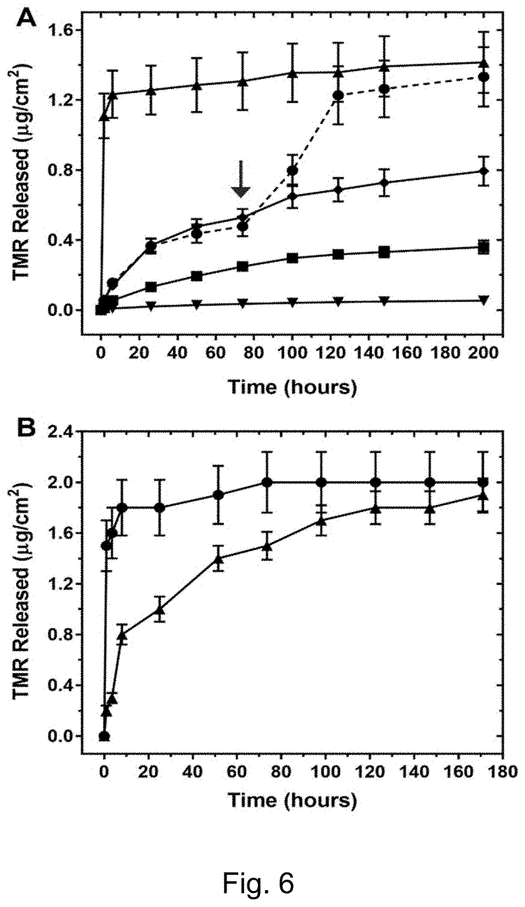

FIG. 6, panel A, shows the release profiles of TMR from electrospun mats without infused oil (solid triangles) and mats infused with silicone oil (u=50 cst; solid diamonds) when these substrates were incubated in PBS at 37° C. These results reveal PCL mats without infused oil to release TMR rapidly, and with a very large burst release, relative to silicone oil-infused PCL mats, which released TMR slowly and gradually over the 8-day period of this experiment. The burst release behavior of the non-oil-infused mats is consistent with the rapid penetration of water and subsequent desorption and diffusion of water-soluble TMR from the PCL nanofibers (Srikar et al., Langmuir 2008, 24: 965-974; Yohe et al., J. Am. Chem. Soc. 2012, 134: 2016-2019; and Carson et al., Pharm. Res. 2016, 33: 125-136). This behavior is not interpreted as resulting from hydrolytic degradation or erosion of PCL upon contact with water, as PCL generally degrades over much more extended periods in physiologically relevant media. These non-oil-infused mats released ˜85% of the total amount of loaded TMR over the first ˜8 days; this release profile is generally consistent with those of other small molecules embedded in electrospun PCL-based materials (Srikar et al., Langmuir 2008, 24: 965-974; Carson et al., Pharm. Res. 2016, 33: 125-136; and Chou et al., J. Controlled Release 2015, 220: 584-591).

In contrast, silicone oil-infused PCL mats released TMR more slowly (FIG. 6, panel A, solid diamonds), a result that was attributed to the ability of the infused oil to prevent rapid infiltration of water. Sustained release of TMR is likely to be governed, at least in part, by concentration-dependent diffusion processes involving the partitioning of TMR from the polymer matrix into the oil phase, and subsequent transport into the surrounding aqueous phase. It is noted that, for these oil-infused substrates, only ˜50% of the initially loaded TMR was released over the 8-day period of this experiment. It is hypothesized that the release of TMR could be manipulated and tuned by altering the physicochemical properties of the lubricating oil phase. For example, it should be possible to prolong release by increasing the viscosity of the silicone oil or lowering the temperature of the surrounding environment (and, thereby, lowering the diffusion rate of TMR through the infused oil layer).

To test this, PCL mats were fabricated and infused with silicone oil having a viscosity 10 times higher (500 cSt; FIG. 9, panel D) than that used in the experiments above and used to perform controlled release experiments at two different temperatures (37° C. and 4° C.). Increasing the viscosity of the oil slowed the release rate significantly (FIG. 6, panel A, solid squares; ˜22% of TMR was released over 8 days) compared to mats infused with lower viscosity oil (50 cSt; ˜50% released). Release was also substantially slower when these samples were incubated at 4° C. (only 3% was released over the first 8 days (FIG. 6, panel A, solid circles); the release of TMR from PCL mats that were not oil-infused was independent of the incubation temperature).

FIG. 6, panel B (filled triangles), shows the release profiles of electrospun mats infused with olive oil (u˜40 cSt) in PBS at 37° C. These olive oil-infused mats also retained their oil and remained slippery during the course of this experiment. However, comparison of these results to those of substrates infused with silicone oil (FIG. 6, panel A, solid diamonds) reveals them to release TMR at a faster rate, even though both of the oils used here have similar viscosities. This result is likely due to increased solubility of TMR in olive oil and accompanying differences in oil/water partition coefficients that could also influence rates at which TMR is transported into the surrounding aqueous phase.

When combined, these results demonstrate that the release of incorporated molecules can be manipulated by changing the physical and chemical properties of the infused lubricating liquid. It is likely that the influence of the oil phase on release rates could be exploited to tune release more broadly to generate new and complex release behaviors from these slippery anti-fouling surfaces (for example, by using blends of different oils or by incorporating strategies that provide dynamic control over the properties of the oil).

It is also likely that these strategies could be combined with other approaches to modify the release behaviors of the PCL meshes (for example, altering the fiber structure, levels of drug loading, increasing mesh thickness, or incorporating other drug carrier materials) to design SLIPS that can release active agents sequentially, without burst release, or over longer periods (Chou et al., J. Controlled Release 2015, 220: 584-591; and Torres-Martinez et al., Curr. Drug Del. 2018, 15: 1360-1374). It is noted that the experiments discussed above were conducted over a period of ˜1 week because some of the liquid-infused samples, in particular those infused with silicone oil, exhibited reductions in slippery character (e.g., decreases in droplet sliding times and increases in droplet sliding angles) when incubated in PBS for longer time periods. These reductions in slippery character were attributed to the gradual loss of silicone oil from the SLIPS coatings over time, and not physical or chemical changes in the underlying nanofiber matrix (in these cases, slippery properties could be recovered by re-infusion of additional silicone oil, and characterization by SEM did not reveal significant changes in the porous nature of the underlying matrix after a week of incubation in PBS).

The long-term stability of these materials can also be improved, optimized, or tuned, in general, in several other ways, including chemical modification of the PCL (or the use of copolymers of PCL containing more hydrophobic monomers), the incorporation of hydrophobic nano/microparticles during electro/blow spinning, or further manipulation of other fabrication parameters. Several of these strategies have been reported previously to manipulate the surface properties and wetting behaviors of PCL-based mats in other contexts (Ma et al., Macromolecules 2005, 38: 9742-9748; Han et al., Langmuir 2009, 25: 9454-9462; Kaplan et al., Biomacromolecules 2014, 15: 2548-2554; Sundaran et al., RSC Advances 2017, 7: 2092-2102; and Zhang et al., Eur. Polym. J. 2019, 116: 386-393). In the context of this current study, however, it is noted that the ability to gradually drain lubricating liquid from these materials also introduces new opportunities to manipulate, and potentially trigger, biodegradation or controlled release behaviors in useful ways.

To explore the feasibility of this latter approach, release experiments were performed similar to those described above in which the surfactant SDS was added to the PBS solutions to trigger a change in the rate at which the infused oil was displaced. The dotted curve in FIG. 6, panel A, shows the result of this experiment (the arrow indicates the time at which SDS (10 mg/mL) was introduced into the surrounding media). This result demonstrates that the addition of surface-active agents can significantly enhance the release of TMR from these materials, consistent with an increase in the rate at which oil is removed from these mats (or the rate at which water is able to displace the oil and/or penetrate deeper into the mat; droplets of water placed on the surfaces of coatings after exposure to SDS did not slide and instead completely wet the surface).

In view of the above results and past studies demonstrating the utility of electro/blow spinning to design PCL nanofibers containing a broad range of other active agents (Woodruff et al., Prog. Polym. Sci. 2010, 35: 1217-1256; and Torres-Martinez et al., Curr. Drug Del. 2018, 15: 1360-1374), experiments were performed to test degradable, oil-infused coatings that contain and release other active agents, particularly antimicrobial agents.

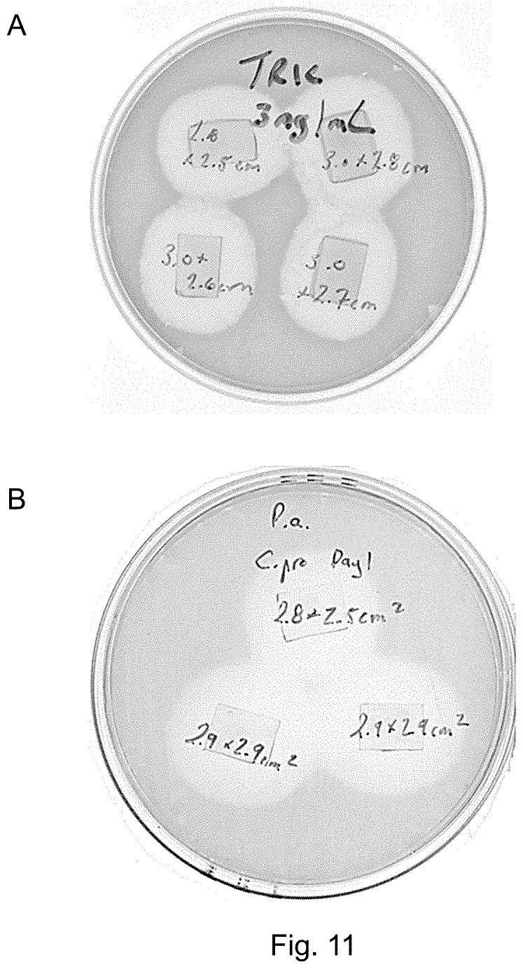

Release of antimicrobial agents from degradable SLIPS. Nanofiber-mats comprising poly(caprolactone) and either the small-molecule antimicrobial agent triclosan or ciprofloxacin were coated onto glass slides by solution blow spinning and infused with different lubricating liquids using the procedures described above. The degradable SLIPS were placed face down on agar plates inoculated with either S. aureus or P. aureginosa and incubated at 37° C. for 24 hours, at which point the nanofiber-mats were examined to determine the presence or absence of zones of inhibition surrounding each coated substrate. Nanofiber-mats comprising either of the small-molecule antimicrobial agents created zones of inhibition around the mats, where there was reduced or no bacterial growth. These results indicate that the antimicrobial agents were successfully released from the nanofiber-mats (see FIG. 11).

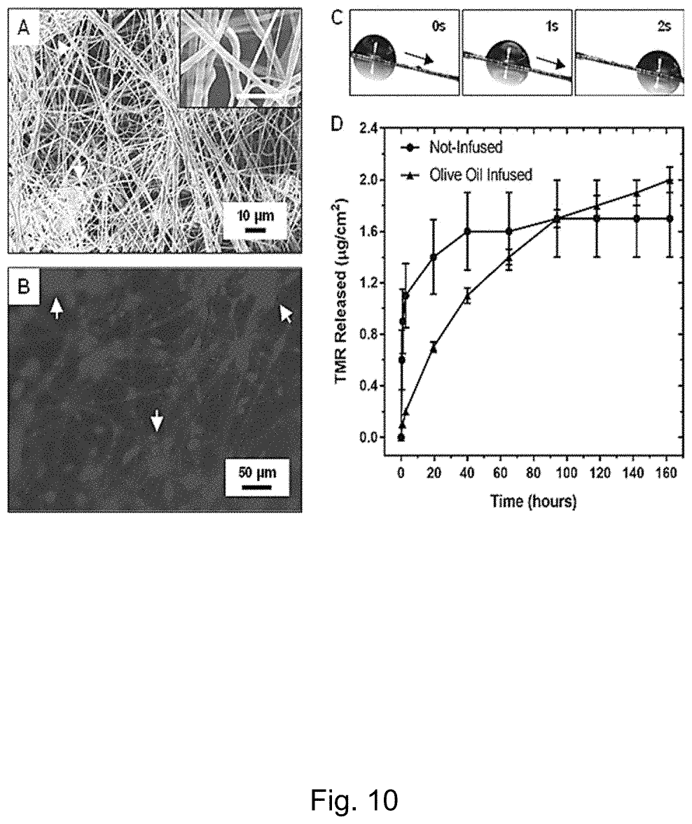

Apart from the advantages of the inherent anti-fouling properties of these slippery coatings, it is noted that strategies to manipulate the timing of the displacement of infused oils from these degradable mats could also be useful in other contexts. Finally, it is noted that the release behaviors described above for oil-infused electrospun PCL mats are also generally applicable to PCL mats fabricated by blow spinning (see FIG. 10 for additional discussion). Of note, blow spun PCL mats infused with olive oil maintained robust slippery behavior upon immersion in PBS for at least 45 days.

### Example 5

Materials and Methods Used to Fabricate SLIPS Described in Examples 1-4

Materials. Polycaprolactone (PCL, Mn=80,000), dichloromethane (DCM), N,N-dimethylformamide (DMF), calcium chloride (anhydrous, ≥97%), sodium citrate tribasic dihydrate (≥99.0%), sodium chloride (NaCl, ≥99.0%), menadione, melittin (from honeybee venom, ≥85%), glycerol 99.0%), and silicone oil (for oil baths [u˜50 cSt and u=500 cSt]) were purchased from Millipore Sigma (Milwaukee, WI). Triton X-100 and Tris-HCL were purchased from Promega (Madison, WI). Tetrahydrofuran (THF) and 3-(N-morpholino) propanesulfonic acid (MOPS) were purchased from Fisher Scientific (Pittsburgh, PA). Methanol (MeOH, 99.9%) was purchased from VWR International (Radnor, PA). Ethanol (EtOH, 200 proof) was obtained from Decon Laboratories (King of Prussia, PA). 5-(and-6)-Carboxytetra-methyl rhodamine (TMR) was purchased from Setareh Biotech (Eugene, OR). Glurataldehyde (50% solution) was purchased from Electron Microscopy Sciences (Washington, PA).

Lake water was locally sourced from Lake Mendota, Madison, WI. Pooled human urine was purchased from Innovative Research Inc. (Novi, MI). Double India Pale Ale beer (Double Dog IPA; Flying Dog Brewery) was purchased from a local liquor store (Madison, WI). Tomato ketchup (Simply Heinz, Kraft Heinz Company) and soy sauce (Kroger) were purchased from Pick 'n Save (Madison, WI). Rust Oleum commercial 5200 system (DTM acrylic) was purchased from The Home Depot (Madison, WI). Fresh porcine blood was collected in a 50 mL conical centrifuge tube with 3.4% sodium citrate in PBS at a ratio of 9:1 (blood:citrate) from the Meat Plant located in the Meat Science & Animal Biologics Discovery Building (UW-Madison, Madison, WI).

Phosphate-buffered saline (PBS) (137 mM NaCl, 2.7 mM KCl, 10 mM phosphate; pH 7.4) was prepared from OmniPur 10× concentrate (Millipore-Sigma, Milwaukee, WI). LB medium (Lennox L Broth) was purchased from Research Products International (Mt. Prospect, IL). Brain heart infusion (BHI) medium was purchased from Teknova (Hollister, CA). Gibco brand RPMI 1640 powder (with L-glutamine and phenol red and without HEPES and sodium bicarbonate), Dulbecco's modified Eagle's medium (DMEM), Dulbecco's phosphate-buffered saline (DPBS, no calcium, no magnesium), and trypsin-EDTA (0.25%, with phenol red) and Invitrogen brand 2,3-bis(2-methoxy-4-nitro-5-sulfophenyl)-2H-tetrazolium-5-carboxanilide (XTT), SYTO-9 green fluorescent nucleic acid stain, and FUN-1 cell stain were purchased from ThermoFisher Scientific (Waltham, MA). Freshly expired human red blood cells (hRBCs) were obtained from the blood bank at the University of Wisconsin-Madison Hospital (Madison, WI). Fetal bovine serum (FBS) was purchased from Peak Serum (Wellington, CO). Water with a resistivity of 18.2 MO was obtained from a Millipore filtration system. All materials were used as received without further purification unless otherwise noted.

General Considerations. Compressed air used to dry samples was filtered through a 0.2 μm membrane syringe filter. Scanning electron micrographs were acquired using a LEO 1550 SEM at an accelerating voltage of 3 kV using an in-lens SEM detector. Coated planar surfaces were cut into 0.5×0.5 cm sections for top-down SEM imaging. For cross-sectional SEM images, substrates were freeze-fractured using the following general protocol: substrates were scored on the back and then dipped in liquid N₂ for two minutes. After the substrates were completely frozen, they were quickly removed from the liquid N₂ and manually snapped along the scored line to expose the cross-section of the coatings. The samples were then mounted on an SEM stub by conductive carbon tape and grounded to the stub using conductive carbon cement. Samples were coated with a thin layer of gold using a gold sputterer operating at 45 mA under a vacuum pressure of 50 mTorr for two minutes prior to imaging.

Digital photographs and videos were acquired using a Samsung Galaxy S8+ smartphone. For contact angle measurements, coated substrates were cut into 1×1 cm squares, and contact angle measurements were obtained using a Dataphysics OCA 15 Plus contact angle goniometer at ambient temperature with 5 μL of Milli-Q water. Advancing and receding contact angles were measured by both the droplet volume change method and the tilting method. Solution fluorescence was measured using a microplate reader (EL800 Universal Microplate Reader, Bio-Tek Instruments, Inc.). Fiber diameters were measured using ImageJ version 1.51j8 software. Fluorescence microscopy images were acquired using an Olympus IX70 microscope and analyzed using the Metavue version 4.6 software package (Universal Imaging Corporation). All data were analyzed using Microsoft Excel for office 360 and plotted using GraphPad Prism 7 (version 7.0 h).

Fabrication of Nanofiber-Based Coatings by Electrospinning. A 150 mg/mL polymer solution was prepared by dissolving PCL in a 1:1 mixture (v/v) of THF and DMF. For fabrication of TMR-loaded nanofiber-based coatings, ˜0.5 mg/mL of TMR was added into the polymer solutions before electrospinning. Electrospinning was performed using a custom-built electrospinning device with a digital syringe pump (Harvard Bioscience Company) at a flow rate of 1.5 mL/h. A 30 cm working distance separated the blunt 22G needle and the 10×10 cm grounded collector. A 20 kV potential (or 25 kV for the TMR-loaded fibers) was applied between the needle tip and collector. Fibers were collected for ˜5 min onto a substrate (e.g., aluminum foil, glass slides, and flexible polyester films) placed directly on the ground collector. After fabrication, nanofiber coatings were stored in a vacuum desiccator prior to use.

Fabrication of Slippery Coatings by Blow Spinning. PCL solution (5% w/v in DCM) was loaded into a 6 mL syringe. The syringe was then placed in a syringe pump (New Era Pump Systems Inc., NY, USA) and connected to the inner (22G) nozzle. The outer (17G) nozzle was connected to a compressed nitrogen tank. Before spraying, the substrate was positioned ˜7.5 cm from the nozzle tip. The syringe pump was set to deliver 40 μL/min and the gas pressure supplied was 20 psi. Each substrate was sprayed with PCL until a uniform coating was obtained (˜2 minutes for a 2 cm² substrate). The total spraying time varied depending on the shape and size of the substrate. For the fabrication of TMR-loaded PCL fibers, ˜0.5 mg/mL TMR was dissolved in a 5 wt % PCL solution in (8:1) v/v DCM:MeOH. The solution was then thoroughly vortexed and sonicated to ensure complete mixing before loading into a syringe. The rest of the fabrication parameters and methods were kept constant to those for the blow spinning of unloaded PCL.

Preparation of Slippery Surfaces and Measurement of Sliding Times. Porous polymer films fabricated by electrospinning or blow spinning, as described above, were infused with lubricating liquids using the following general protocol. The required number of oil droplets (˜10 μL) was placed at different spots onto a coated surface tilted at angles ranging from 70° to 90°. The samples were left tilted for −30 min before use to allow the oil to spread and the excess oil to drain off the substrates through gravity-driven processes. For sliding time measurements, 20 μL droplets of various test liquids were placed onto the oil-infused surface inclined at an angle of 20°, and the time required to slide a fixed length was measured using a digital timer.

Loading and Release of TMR. TMR-loaded nanofiber-mats coated onto glass slides (1×2.0 cm; 2 cm²) were infused with different lubricating liquids using the procedure described above. All of the infused and non-infused substrates were incubated in 4 mL of PBS buffer (pH 7.4) at 37° C. or 4° C. At designated time points, the buffer was removed for analysis and replaced with fresh buffer. Concentrations of released TMR were measured using a fluorometer and compared to a standard curve for TMR in PBS buffer. All release experiments were conducted with n=4. To characterize the total amount of TMR incorporated into these nanofiber-mats, TMR was extracted from the mats by stirring (at 200 rpm) TMR-loaded mats (1×1.0 cm; 1 cm²) in 500 μL DMF at room temperature for 30 min, followed by sonication for 5 s. The samples were then centrifuged at 5000 g for 1 min to separate out any polymer particulates. The DMF solution was isolated and diluted 9× in Milli-Q water, and the amount of TMR extracted from the mats into DMF was measured using a fluorometer and compared to a standard curve of TMR in Milli-Q water:DMF [1:9].

Release of TMR from liquid-infused coatings fabricated by blow spinning. Nanofiber-based PCL matrices were fabricated and loaded with TMR. FIG. 9, panels A and B, show the SEM images and fluorescence microscopy images of these mats, respectively. Inspection of these images reveals a network of randomly aligned TMR-loaded fibers (mean diameter=288 nm±105 nm; see FIG. 7 for the additional characterization of nanofiber sizes) with a few non-uniformities consisting primarily of polymeric aggregates and beads (marked by arrows in FIG. 9). The reasons for the appearance of these non-uniformities in TMR-loaded fibers are unclear (no such defects were observed in the blow spun PCL nanofibers alone (no TMR); see FIG. 4, panels B,C); however, these defects do not influence the slippery behaviors of these materials after infusion with oils. FIG. 9, panel C, shows 10 μL aqueous droplets sliding on these liquid-infused surfaces unimpeded (θtilt=10°). FIG. 9, panel D, shows the release profile of TMR from ‘dry’ (solid circles) and olive oil-infused (solid triangles) blow spun PCL meshes. The olive oil-infused mats released TMR at a much slower rate with a significantly smaller burst release phase (˜0.2 μg/cm⁻² released in first 3 hours) as compared to ‘dry’ PCL mats (˜1.1 μg/cm⁻² released in first 3 hours). These results are consistent with materials described above fabricated by electrospinning and emphasize the role of the lubricating liquid in preventing the infiltration of water in these surfaces and a concentration-dependent diffusion of TMR through the infused liquid phase.

### Example 6

Fabrication of SLIPS Using Alternative Degradable Polymers

Although poly(ε-caprolactone) (PCL) is exemplified in the examples above, biodegradable materials other than PCL may be used to fabricate the slippery anti-fouling materials of the present invention. In one such embodiment, a poly(lactide-co-glycolide) (PLGA) solution is prepared in a mixture (v/v) of THF and DMF and loaded into a syringe. Electrospinning is performed using a custom-built electrospinning device with a digital syringe pump (Harvard Bioscience Company), in which a 30 cm working distance is used to separate a blunt 22G needle from a 10×10 cm grounded collector. A voltage potential is applied between the needle tip and collector and fibers are collected directly on the ground collector. The porous polymer coatings are then infused with silicone oil by pipetting oil droplets (˜10 μL) at different locations on coated surfaces tilted at angles ranging from 70° to 90°. The samples are left tilted for ˜30 min before use to allow the oil to spread and the excess oil to drain off the substrates through gravity-driven processes.

In another embodiment, a salicylic acid-based poly(anhydride-ester) solution is prepared in a mixture (v/v) of dichloromethane (DCM) and dimethylformamide (DMF) and is loaded into a syringe. Electrospinning is performed using a custom-built electrospinning device with a digital syringe pump (Harvard Bioscience Company), in which a 30 cm working distance is used to separate a blunt 22G needle from a 10×10 cm grounded collector. A voltage potential is applied between the needle tip and collector and fibers are collected directly on the ground collector. The porous polymer coatings are then infused with silicone oil by pipetting oil droplets (˜10 μL) at different locations on coated surfaces tilted at angles ranging from 70° to 90°. The samples are left tilted for ˜30 min before use to allow the oil to spread and the excess oil to drain off the substrates through gravity-driven processes.

### Example 7

Characterization of Fabricated SLIPS

Characterization of Fungal Biofilm Adhesion on SLIPS-Coated Substrates. Candida albicans (SC 5314) was obtained from American Type Culture Collection (Manassas, VA) and was streaked on a yeast peptone dextrose (YPD) agar plate from a frozen stock solution and grown overnight at 30° C. For each assay, a colony was collected from the YPD plate and grown overnight in 15 mL centrifuge tubes in liquid YPD broth medium at 30° C. C. albicans colonies harvested from YPD plates stored in the refrigerator at 4° C. were grown overnight at 30° C. in liquid YPD medium. Cells were washed with PBS and resuspended in RPMI 1640 medium buffered with MOPS (pH 7.0) and supplemented with 5% fetal bovine serum to stimulate biofilm formation. The cell density was manually adjusted to 106 cfu mL⁻¹. PCL nanofiber meshes were cut into multiple 1×1 cm segments. Each segment was individually stuck to the bottom of a well in a 24-well microtiter plate, and then infused with silicone oil. Bare uncoated wells were used as controls. C. albicans subculture was then added to each well in 1 mL aliquots, and the plates were incubated under static conditions at 37° C. At the end of a 24 h period, all of the wells were washed with DI water twice to remove planktonic cells and loosely attached biofilms and stained with a green fluorescent stain (FUN-1) according to the manufacturer's protocol. The excess staining solution was removed by dabbing on a paper towel, after which the substrates were transferred to the wells of a new 24-well plate. Yeast biofilms were then imaged using an Olympus IX71 fluorescence microscope.

Characterization of Bacterial Biofilm Adhesion on SLIPS-Coated Substrates. Freezer stocks of (i) Staphylococcus aureus (RN6390b) (Novick et al., EMBO journal 1993, 12: 3967-3975) in 1:1 BHI medium:glycerol (50% v/v in Milli-Q water) and (ii) Escherichia coli (K-12 MG1655; obtained from The Coli Genetic Stock Center, Yale University, New Haven, CT) in 1:1 LB medium:glycerol (50% v/v in Milli-Q water) were maintained at −80° C. Overnight cultures of S. aureus and E. coli were grown in either BHI or LB medium, respectively, at 37° C. with shaking at 200 rpm. To prepare the inoculating subcultures, the overnight cultures of S. aureus and E. coli were resuspended 1:100 in fresh BHI medium (+1% (w/v) glucose) or fresh LB medium, respectively. Both bare glass substrates and SLIPS-coated substrates were placed individually into the wells of a 24-well microtiter plate. Bacterial subculture (S. aureus or E. coli) was then added to each well in 1 mL aliquots, and the plates were incubated under static conditions at 37° C. At the end of a 24 h period, substrates were washed with DI water twice to remove planktonic cells and loosely attached biofilms and then stained with a green fluorescent nucleic acid stain (SYTO-9) according to the manufacturer's protocol. The excess staining solution was removed by dabbing on a paper towel, after which the substrates were transferred to the wells of a new 24-well plate. Bacterial biofilms were then imaged using an Olympus IX71 fluorescence microscope.

Characterization of Mammalian Cell Attachment on SLIPS-Coated Surfaces. All surfaces (bare glass and SLIPS-coated) were sterilized prior to the seeding of cells by exposure to UV light for 20 min in a biological safety cabinet. The substrates were then placed individually into the wells of 24-well tissue culture-treated polystyrene microtiter plates. 3T3 mouse fibroblast (NIH/3T3) cells were maintained in Dulbecco's modified Eagle's medium (DMEM) supplemented with 10% v/v fetal bovine serum, with 100 units mL⁻¹ penicillin and 100 μg mL⁻¹ streptomycin, at 37° C. and 5% CO2 in 6-well plates. Cells were passaged upon 70-80% confluency by gently washing the cell layer with Dulbecco's phosphate-buffered saline (DPBS) and then detaching them from the bottom of the wells with a 0.25% trypsin-EDTA solution. Confluent 3T3 cells from an ongoing cell line were detached during passaging and seeded on both SLIPS-coated and bare glass substrates at initial densities of 100,000 cells/mL in 750 μL of the growth medium, after which they were incubated at 37° C. for 24 h. Following incubation, the growth medium was aspirated and the substrates were washed twice gently with PBS. For imaging cells retained on the substrates, cells were stained with 500 μL of SYTO-9 staining solution for 30 min. Following incubation, the staining solution was aspirated and the substrates were then transferred to the wells of a new 24-well plate and imaged using an Olympus IX71 fluorescence microscope.

Hemolysis Assays. Hemolysis assays were performed based on a previously reported protocol with minor modifications (Raguse et al., J. Am. Chem. Soc., 2002, 124: 12774-12785; and Porter et al., J. Am. Chem. Soc. 2005, 127: 11516-11529).

Briefly, human red blood cells (hRBCs) were washed with Tris-buffered saline (TBS, 10 mM Tris-HCl, 100 mM NaCl, pH 7.5) until clear supernatant was obtained (at least three washes). A 400 μL aliquot of 1% hRBCs in TBS was pipetted on top of SLIPS-coated and uncoated glass slides (1×1 cm) stored in the wells of a 24-well plate. The substrates were then incubated at 37° C. for 3 hours. Triton X-100 (0.1% w/v) served as a positive lysis control and TBS served as a negative lysis control. After incubation, the hRBC solution from the 24-well plate was transferred to microcentrifuge tubes and centrifuged at 1800 g for 5 min. Supernatant (50 μL) was transferred into a 96-well UV-transparent microplate, and all wells were diluted 2× with 50 μL TBS. Absorbance of each well was measured at 405 nm using a plate reader. The percent of hemolysis was calculated as:

$$Hemolysis ( \% ) = \frac{( {A}_{405}^{sample} - {A}_{405}^{negative control} )}{( {A}_{405}^{positive control} - {A}_{405}^{negative control} )} \times 100$$

where A₄₀₅ negative control and A₄₀₅ positive control are the average absorbance values at 405 nm of the 1% hRBCs (in TBS) and 1% hRBCs in (0.1% w/v Triton X-100 in TBS), respectively.

Platelet Adhesion Assays. Anticoagulated blood was transferred into 15 mL conical centrifuge tubes (CELLTREAT Scientific Products, MA) immediately after collection and centrifuged at 200 g for 15 min. The platelet-rich plasma (PRP) portion was collected carefully with a pipet so as not to disturb the buffy coat. Calcium chloride (CaCl₂; 250 mM in Milli-Q water) was added to the platelet solution to achieve a final concentration of 1 mM. Bare glass substrates and SLIPS-coated substrates were placed individually into the wells of a 24-well microtiter plate. Platelet solution was then added to each well in 700 μL aliquots and the plates were incubated under static conditions at 37° C. for 2 hours. After incubation, the platelet solution was removed from the wells and the substrates were washed with DI water to remove loosely adhered platelets. The adhered platelets on the samples were fixed using 2.5 wt % glutaraldehyde (4° C., 10 h). Finally, the fixed platelets were dehydrated with a series of ethanol solutions (30, 50, 70, 90, and 100 vol %). The samples were then gold-sputtered and characterized using SEM.

Characterization of Physical and Chemical Robustness of Liquid-Infused Surfaces. For experiments to characterize the stability of slippery coatings upon immersion in ketchup, a SLIPS-coated glove was immersed in a beaker full of ketchup 10×, with each dipping cycle lasting for few seconds. The influence of smudging was characterized by touching and rubbing liquid-infused materials with a gloved finger using moderate pressure ˜10 times in different areas of the coated substrate. For experiments to characterize the stability of slippery coatings upon rubbing and abrasion, a laboratory Kimwipe was rubbed along the coated surface of polycarbonate laboratory glasses with moderate pressure for ˜1 minute. The stability of liquid-infused materials upon exposure to blood was evaluated by repeated (˜10×) dispensing of blood on a SLIPS-coated watch glass and then tilting the substrate to remove the blood.

The above examples illustrate new design principles for the fabrication of anti-fouling liquid-infused surfaces using building blocks that are degradable and biocompatible. These approaches are single-step and straightforward to implement, and useful for coating objects of arbitrary size, composition, and shape. These biocompatible and degradable liquid-infused surfaces remain slippery and anti-fouling to a broad range of commercially relevant liquids, viscoelastic materials, mammalian cells, and microorganisms, including several notorious human microbial pathogens. The approaches described above also enable the incorporation of new controlled release behaviors to these inherently anti-fouling materials. The results show that small molecules can be released from these degradable anti-fouling coatings at rates that can be manipulated by the properties of the infused liquid phase or by the rate of displacement of infused oil by a surrounding aqueous phase.

Overall, these results provide new design strategies and fabrication techniques that expand the range of functions and behaviors of SLIPS, address emerging challenges related to environmental sustainability and biocompatibility, and enable scalable fabrication. It is anticipated that these approaches will prove useful for the design of multifunctional and environmentally sustainable anti-fouling surfaces with utility in a broad range of fundamental and applied contexts.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

One of ordinary skill in the art will appreciate that starting materials, reagents, purification methods, materials, substrates, device elements, analytical methods, assay methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that the use of such terms and expressions exclude any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

All references cited herein are hereby incorporated by reference in their entirety to the extent that there is no inconsistency with the disclosure of this specification. Some references provided herein are incorporated by reference to provide details concerning sources of starting materials, additional starting materials, additional reagents, additional methods of synthesis, additional methods of analysis, additional biological materials, and additional uses of the invention. All headings used herein are for convenience only. All patents and publications mentioned in the specification are indicative of the levels of skill of those skilled in the art to which the invention pertains, and are herein incorporated by reference to the same extent as if each individual publication, patent or patent application was specifically and individually indicated to be incorporated by reference. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

1. An anti-fouling degradable material comprising:
a) a degradable porous matrix comprising one or more degradable polymers, one or more biocompatible polymers, one or more degradable linkers, or combinations thereof; and
b) a lubricating liquid or emulsion covering a first surface of the degradable porous matrix, wherein said lubricating liquid or emulsion at least partially fills pores of the degradable porous matrix.

2. The material of claim 1, wherein the degradable porous matrix degrades after exposure to specified molecules or environmental conditions selected from the group consisting of: water, microorganisms, changes in temperature, changes in pH, aerobic environments, oxidizing/reducing agents, sunlight, ultraviolet light, and combinations thereof.

3. The material of claim 1, wherein the degradable porous matrix comprises one or more biodegradable polymers or biocompatible polymers, and is generated by electrospinning or blow spinning.

4. The material of claim 1, wherein the degradable porous matrix comprises one or more biodegradable polymers selected from the group consisting of polylactide, polyglycolide, polycaprolactone, poly(sebacic acid), combinations thereof, and copolymers thereof.

5. The material of claim 1, wherein the degradable porous matrix comprises poly(ε-caprolactone) (PCL).

6. The material of claim 1, wherein at least 30% of the material by weight is able to degrade within a 12 month period of time.

7. The material of claim 1, wherein no more than 10% of the material by weight degrades within a 1 month period of time.

8. The material of claim 1, wherein the degradable porous matrix is a nanofiber mesh or a nanofiber mat.

9. The material of claim 1, wherein the lubricating liquid or emulsion comprises an oil selected from the group consisting of: a hydrocarbon-based oil, a biomass-derived oil, a silicone oil, an edible food derived oil, a mineral oil, a perfluorinated oil, a liquid crystalline material, and combinations thereof.

10. The material of claim 1, wherein the lubricating liquid or emulsion is an emulsion comprising a liquid continuous phase and a plurality of liquid droplets dispersed within the continuous phase.

11. The material of claim 1 further comprising one or more molecules dispersed within the lubricating liquid, emulsion, and/or polymer matrix, wherein the material is able to controllably release the one or more molecules when the material is exposed to or immersed into a surrounding environment.

12. The material of claim 11, wherein the time necessary to release at least 50% of the one or more molecules dispersed within the lubricating liquid or emulsion to the surrounding environment is 10 days or more.

13. The material of claim 1, wherein the lubricating liquid or emulsion at least partially filling the pores of the degradable porous matrix allows other liquids and compounds to contact the degradable material without adhering to the degradable material.

14. The material of claim 1, wherein the degradation of the material results in changes in one or more physical or chemical properties of the material selected from the group consisting of: changes in the sliding time of liquid droplets and other compounds on the surface of the material, hydrophobicity or hydrophilicity of the material, chemical reactivity of the material, changes in the physical appearance of the material, and combinations thereof.

15. A method for preventing or reducing fouling of a substrate comprising the steps of: depositing an anti-fouling degradable material on said substrate, wherein said material comprises:
a) a degradable porous matrix comprising one or more degradable polymers, one or more biocompatible polymers, one or more degradable linkers, or combinations thereof; and
b) a lubricating liquid or emulsion covering a first surface of the degradable porous matrix, wherein said lubricating liquid or emulsion is optionally degradable.

16. The method of claim 15 further comprising generating the degradable porous matrix by electrospinning or blow spinning one or more degradable polymers and/or biocompatible polymers.

17. The method of claim 15 wherein the degradable porous matrix degrades after exposure to specified molecules or environmental conditions selected from the group consisting of: water, microorganisms, changes in temperature, changes in pH, aerobic environments, oxidizing/reducing agents, sunlight, ultraviolet light, and combinations thereof.

18. The method of claim 15 further comprising degrading at least 30% of the material by weight within a 12 month period of time.

19. The method of claim 15, wherein the degradable porous matrix comprises one or more biodegradable polymers selected from the group consisting of polylactide, polyglycolide, polycaprolactone, poly(sebacic acid), combinations thereof, and copolymers thereof.

20. The method of claim 15, wherein the lubricating liquid or emulsion at least partially fills pores of the degradable porous matrix and allows other liquids and compounds to contact the degradable material without adhering to the degradable material.

21. The method of claim 15, the lubricating liquid or emulsion at least partially fills pores of the degradable porous matrix allows other liquids and compounds to slide off the first surface without adhering to the first surface, wherein fouling liquids, compounds, substances, and microorganisms are able to slide off the first surface with a sliding angle of 20°.

22. The method of claim 15 further comprising loading one or more molecules within the lubricating liquid, emulsion, or polymer matrix and controllably releasing the one or more molecules when the material is exposed to or immersed into a surrounding environment.

23. A method for fabricating an anti-fouling degradable material able to reduce, inhibit, or modulate the behaviors of non-adherent pathogens in surrounding media, said method comprising the steps:
a) forming a degradable porous matrix on a substrate, wherein said degradable porous matrix comprises one or more degradable polymers, one or more biocompatible polymers, one or more degradable linkers, or combinations thereof;
b) exposing the degradable porous matrix to a lubricating liquid or emulsion, wherein said lubricating liquid or emulsion coats at least a portion of the degradable porous matrix and said lubricating liquid or emulsion at least partially fills the pores of at least a portion of said degradable porous matrix, wherein the lubricating liquid or emulsion comprises a vegetable oil or seed oil, thereby forming an anti-fouling material on said substrate, wherein at least 30% of the material by weight is able to degrade within a 12 month period of time; and
c) loading one or more molecules onto said degradable porous matrix and/or into said lubricating liquid or emulsion, wherein the one or more molecules are antimicrobial agents, antifungal agents, antibacterial agents, agents that modulate bacterial or fungal quorum sensing, agents that attenuate virulence, or combinations thereof.

24. The method of claim 23, wherein the non-adherent pathogens are bacteria, fungi, or a combination thereof.

25. The method of claim 23, wherein the degradable porous matrix degrades after exposure to specified molecules or environmental conditions selected from the group consisting of: water, microorganisms, changes in temperature, changes in pH, aerobic environments, oxidizing/reducing agents, sunlight, ultraviolet light, and combinations thereof.
